(19) United States
(12) Patent Application Publication
(10) Pub. No.: US 2012/0044140 A1
(43) Pub. Date: Feb. 23, 2012

(54) INFORMATION DISPLAY SYSTEM AND PROGRAM, AND OPTICAL INPUT SYSTEM, PROJECTION-TYPE IMAGES AND DISPLAY APPARATUS

(75) Inventors: Tadahisa KOYAMA, Gifu-City (JP); Kazuo Ishimoto, Osaka (JP); Toru Watanabe, Ogaki-City (JP); Miwa Yoneda, Ogaki-City (JP)

(73) Assignee: SANYO Electric Co., Ltd., Moriguchi City (JP)

(21) Appl. No.: 13/211,642

(22) Filed: Aug. 17, 2011

(30) Foreign Application Priority Data
Aug. 19, 2010 (JP) 2010-183819
Aug. 31, 2010 (JP) 2010-194513
Aug. 31, 2010 (JP) 2010-194779

(51) Int. Cl. G06F 3/033

(52) U.S. Cl. 345/157

(57) ABSTRACT

An information display system includes a pointing device and a control apparatus for detecting the locus of tip of the pointing device. The pointing device includes a light emitting part for irradiating the radiated light that radiates with the tip of the pointing device as the center on a predetermined plane. A camera captures images of a region including the radiated light on the predetermined plane. A radiated light detector detects the radiated light from the images captured by the camera. An estimation unit estimates the position of the tip of the pointing device from the radiated light detected by the radiated light detector.

### CROSS-REFERENCE TO RELATED APPLICATIONS

This application is based upon and claims the benefit of priority from the prior Japanese Patent Applications No. 2010-183819, filed on Aug. 19, 2010, No. 2010-194779, filed on Aug. 31, 2010 and No. 2010-194513, filed on Aug. 31, 2010, the entire contents of which are incorporated herein by reference.

### BACKGROUND OF THE INVENTION

1. Field of the Invention

The present invention relates to an information display technology by which to detect loci of a pointing device and display the detected loci thereof.

2. Description of the Related Art

Projection-type display systems are in wide practical use today. The projection-type display system detects loci of a pointing device on a screen and draws the loci of the pointing device in projected images. This projection-type display system is used for presentation and lectures at schools, for example. This kind of system generally works as follows. A camera for capturing an image of the entire screen is installed, and light is emitted from the tip of the pointing device. Then the light emitted therefrom is detected from an image captured by the camera and thereby the locus of the pointing device is detected. Yet, a problem arises where the camera cannot capture the image of the tip of the pointing device and therefore the locus cannot be tracked when an operator of the pointing device is located between the camera and the screen.

Known is a projection-type display apparatus in which an electronic pen equipped with an infrared light emitting unit and an ultrasound wave generator is used and the coordinates of the electronic pen on projected images is calculated as follows. That is, the coordinates of the electronic pen on the projected image is calculated based on a difference between time when the infrared beam is received by an infrared receiver and time when the ultrasound wave is received by a plurality of ultrasound receivers. As a result, the coordinates of the electronic pen can be calculated even though the electronic pen is positioned behind a user as viewed from the projection-type display apparatus.

In the above-described technique, a transceiver device for ultrasound waves needs to be each incorporated into the electronic pen and the projection-type display apparatus, thereby complicating the structure and raising the overall cost.

### SUMMARY OF THE INVENTION

The present invention has been made in view of the foregoing circumstances, and a purpose thereof is to provide a technology for identifying the position of a pointing device in the event that the image of the tip of the pointing device cannot be picked up by a camera, in a system that picks up light projected from the pointing device onto a screen and detects the locus of the pointing device.

One embodiment of the present invention relates to an information display system including a pointing device and a control apparatus for detecting a locus of tip of the pointing device. The pointing device includes: a light emitting part configured to irradiate radiation light that radiates with the tip of the pointing device on a predetermined plane as a center. The control apparatus includes: an image pickup unit configured to pick up a region including the radiation light on the predetermined plane; a detector configured to detect the radiation light from an image picked up by the image pickup unit; and an estimation unit configured to estimate the position of the tip of the pointing device from the radiation light detected by the detector.

Another embodiment relates to an information display system including a pointing device and a control apparatus for detecting a locus of tip of the pointing device. The pointing device includes: a first light-emitting part configured to form a first irradiation region along a direction of the tip thereof; a second light-emitting part configured to form a second irradiation region in such a manner as to surround the first irradiation region; and a switch configured to turn on and off either one of the first light-emitting part and the second light-emitting part. The control apparatus includes: an image pickup unit configured to pick up images of the first irradiation region and the second irradiation region on a predetermined plane; a detector configured to detect the first irradiation region and the second irradiation region from an image picked up by the image pickup unit; an estimation unit configured to estimate the position of the tip of the pointing device from a position or shape of the first irradiation region or the second irradiation region; and a notification unit configured to convey an operation of the switch to an external device when the first irradiation region or the second irradiation has been detected.

Optional combinations of the aforementioned constituting elements, and implementations of the invention in the form of methods, apparatuses, systems, recording media, computer programs and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 illustrates a general structure of a projection display system according to a first embodiment of the present invention;

FIG. 2A illustrates a structure of a pen-shaped device according to a first embodiment;

FIG. 2B is a cross-sectional view of a pen-shaped device according to a first embodiment;

FIG. 3 is an example of the shape of radiated light irradiated onto a screen when a pen-shaped device is pressed against the screen vertically;

FIG. 4 illustrates a method for estimating a pen-tip position from the radiated light picked up by a camera;

FIG. 5 is a diagram showing a structure of a projection-type display apparatus according to a first embodiment;

FIG. 6 is a flowchart of a process for drawing a locus on a screen using a pen-shaped device;

FIGS. 7A and 7B each explains a method for estimating the inclination of a pen-shaped device relative to a screen plane by the use of the pen-shaped device;

FIGS. 8A and 8B each explains a method for detecting the rotation of a pen-shaped device by the use of the pen-shaped device;

FIGS. 9A and 9B each explains a method for estimating the distance of a pen-shaped device relative to a screen plane by the use of the pen-shaped device;

FIG. 10A shows a pen-shaped device for which the positions of slits are asymmetrical;

FIG. 10B shows radiated light on a screen when the pen-shaped device of FIG. 10A is used;

FIG. 11A shows a pen-shaped device for which the width of each slit is enlarged;

FIG. 11B shows radiated light on a screen when the pen-shaped device of FIG. 11A is used;

FIG. 12A shows a pen-shaped device whose slits extend to the tip of the pen-shaped device;

FIG. 12B shows radiated light on a screen when the pen-shaped device of FIG. 12A is used;

FIG. 13A shows a pen-shaped device having an increased number of slits formed in an enclosure;

FIG. 13B shows radiated light on a screen when the pen-shaped device of FIG. 13A is used

FIG. 14A is a cross-sectional view of a pen-shaped device according to a second embodiment of the present invention;

FIG. 14B shows an irradiation region formed by a light-emitting element when the pen-shaped device of FIG. 14A is used;

FIG. 15 is a diagram showing a structure of a projection-type display apparatus according to a second embodiment;

FIG. 16A is a cross-sectional view of a pen-shaped device according to a third embodiment of the present invention;

FIG. 16B shows irradiation regions formed by a light-emitting element when the pen-shaped device of FIG. 16A is used;

FIG. 17 illustrates an example of the application of an optical input system according to a fourth embodiment of the present invention;

FIG. 18 is a diagram showing the basic principle of an optical input system according to a fourth embodiment;

FIG. 19 is a diagram showing a structure of a projection-type image display system according to a fourth embodiment;

FIG. 20A to FIG. 20D illustrate examples of direct light and reflected light captured by an image pickup unit;

FIG. 21A to FIG. 21D are diagrams showing electronic pens suitable for use in an optical input system according to a fourth embodiment;

FIG. 22 illustrates a general structure of a projection display system according to a fifth embodiment of the present invention;

FIG. 23 illustrates a structure of a pen-shaped device according to a fifth embodiment;

FIG. 24 is a diagram showing a structure of a projection-type display apparatus according to a fifth embodiment;

FIG. 25 illustrates how loci are drawn on a screen by the use of a pen-shaped device;

FIGS. 26A and 26B illustrate how a menu icon is displayed near the end of locus;

FIG. 27 is a flowchart of a process for drawing a locus on a screen by the use of a pen-shaped device;

FIG. 28 is an example of projection image in a sixth embodiment of the present invention;

FIG. 29 shows a setting where the color of pen is changed by a toggle switch;

FIG. 30 shows a setting where a pen function and an eraser function are switched by a toggle switch;

FIG. 31 is a diagram showing changes in function when the toggle switch of FIG. 29 and the toggle switch of FIG. 30 are used in combination;

FIG. 32 explains a method employed when a user sets a desirable function to a toggle switch icon; and

FIG. 33 illustrates a general structure of a projection display system using a laser point.

### DETAILED DESCRIPTION OF THE INVENTION

The invention will now be described by reference to the preferred embodiments. This does not intend to limit the scope of the present invention, but to exemplify the invention.

### First Embodiment

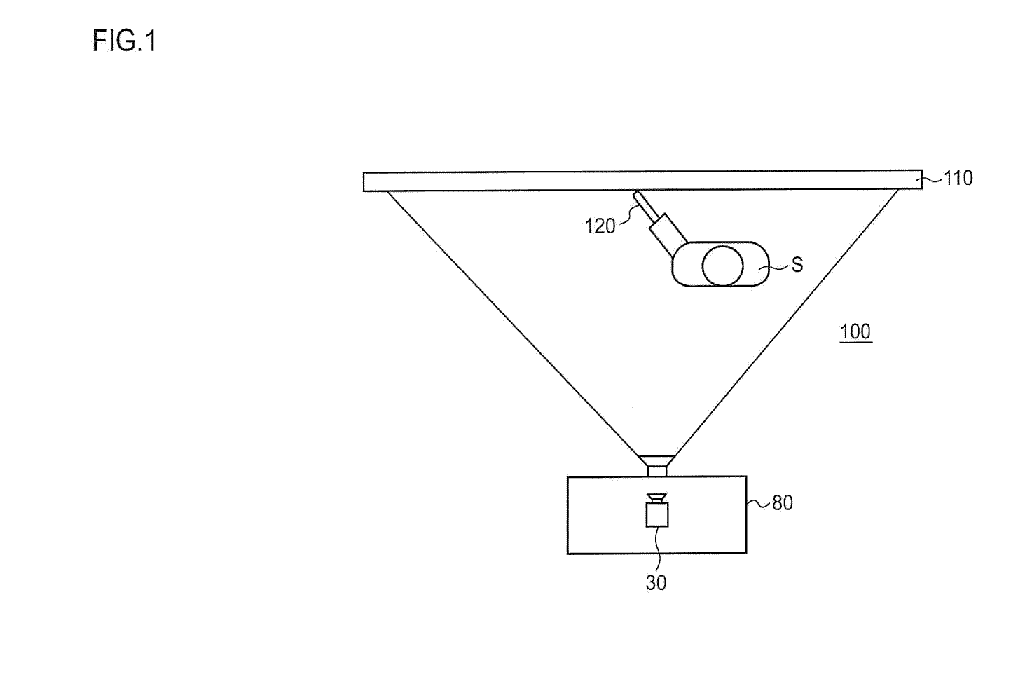

FIG. 1 illustrates a general structure of a projection display system 100 according to a first embodiment of the present invention. The projection display system 100 includes a projection-type display apparatus 80 (hereinafter referred to as “projector” also), a screen 110 onto which images are projected from the projection-type display apparatus 80, and a pointing device 120 operated by a user S. The projection-type display apparatus 80 includes a camera 30 for taking images toward the screen 110. For example, the camera 30 is installed so that the optical center of the camera 30 is set parallel to the optical center of projection light projected from the projection-type display apparatus 80.

In the first embodiment, the user S operates to draw lines and characters by moving the pointing device 120 in such a manner that the pen-shaped pointing device 120 is in contact with a projection plane of the screen 110. The projection-type display apparatus 80 detects the locus of the tip of the pointing device 120, based on images captured by the camera 30. Then the projection-type display apparatus 80 produces an image where the locus has been drawn and then projects the image onto the screen 110.

The camera 30 is arranged so that almost entire screen 110 can be contained within a field of view of the camera 30 in order for the camera 30 to take the images of the movement of the pointing device 120 on a projected image. As shown in FIG. 1, the screen 110 and the camera 30 are preferably positioned such that the camera 30 is located right in front of the screen 110. However, the camera 30 may be placed off horizontally from the projection-type display apparatus 80. Alternatively, the camera 30 may be placed nearer the screen than the projection-type display apparatus 80. Also, a plurality of cameras 30 may be used.

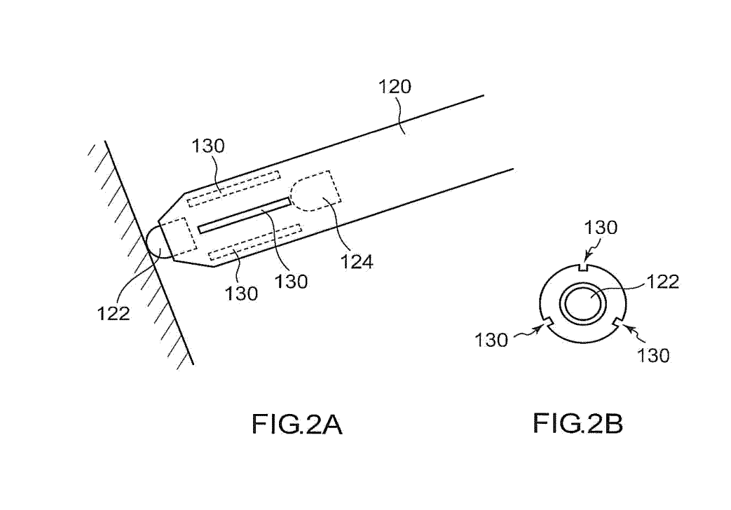

FIG. 2A illustrates a structure of a pen-shaped pointing device (hereinafter referred to simply as “pen-shaped device”) 120 according to the first embodiment. An operation of the pen-shaped device 120 being pressed against and moved along the projection plane of the screen is detected while the user holds it in the same manner as a regular ball-point pen or the like. In FIG. 2A, the solid line indicates the outer shape of the pen-shaped device 120, whereas the dotted line indicates the internal structure or back-side shape thereof.

A switch 122 having a semispherical tip part is mounted on the tip of the pen-shaped device 120. A light-emitting element 124, such as an LED (Light Emitting Diode), to which the power is supplied from a not-shown battery, is provided in an enclosure of an approximately cylindrical form. A configuration is such that when the user presses the tip of the pen-shaped device 120 against the screen 110, the switch 122 is pressed inwardly and thereby the light-emitting element 124 lights up.

A plurality of long and thin slits 130, which extend from the light-emitting element 124 toward the tip of the pen-shaped device 120, are formed in the enclosure of the pen-shaped device 120. Though the slit 130 is basically of a rectangular shape extending along the axis of the pen-shaped device 120, the slit 130 may be of other shapes.

It is preferable that the central axis of the pen-shaped device 120, the contact point of the switch 122 to the screen, and the light emission center of the light-emitting element 124 are disposed coaxially to each other. Though the shape of the enclosure of the pen-shaped device 120 is not limited to the cylindrical form only and may be of arbitrary shapes, the slits 130 formed in the enclosure of the pen-shaped device 120 are preferably disposed such that each slit 130 is positioned equidistantly from the central axis of the pen-shaped device 120.

FIG. 2B is an end view of the pen-shaped device 120 as viewed from the tip side. In the first embodiment, three slits 130 are formed equally spaced apart from each other in a circumferential direction.

The length of the slit 130 is preferably selected such that even if the pen-shaped device 120 is hidden behind the shadow of the user S as viewed from the camera 30, the radiated light can extend up to a position such that the radiated light on the screen can escape from the shadow of the user S and can be captured by the camera 30.

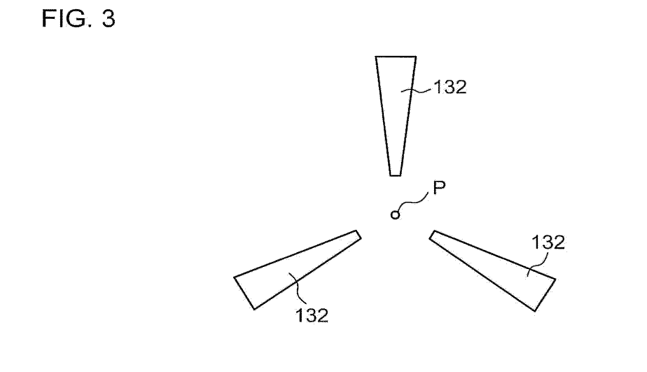

FIG. 3 is an example of the shape of light irradiated onto the screen from the pen-shaped device 120 when the pen-shaped device 120 is pressed against the screen vertically. As the switch 122 of the pen-shaped device 120 is pressed, the light-emitting element 124 lights up and light escapes through the slits 130. As shown in FIG. 3, the light escaped from each slit 130 forms long and thin radiated light 132 of an approximately trapezoidal shape which radiates with a tip P of the pointing device 120 (i.e., the contact position of the switch 122 to the screen) as the center. Since the slit 130 does not completely extend to the tip of the pen-shaped device 120, the radiated light 132 appears in a position some distance away from a pen-tip position P.

If the light-emitting element 124 is a luminous body having a strong directive property like LED, a prism or mirror may preferably be placed in an irradiation direction of the light-emitting element 124 so that the light can sufficiently escape from the slits 130. The illumination intensity and color of the light-emitting element 124 are selected to the degree that the outline of at least part of the radiated light can be recognized in a captured image on the screen, in an assumed use environment of the projection-type display apparatus 80.

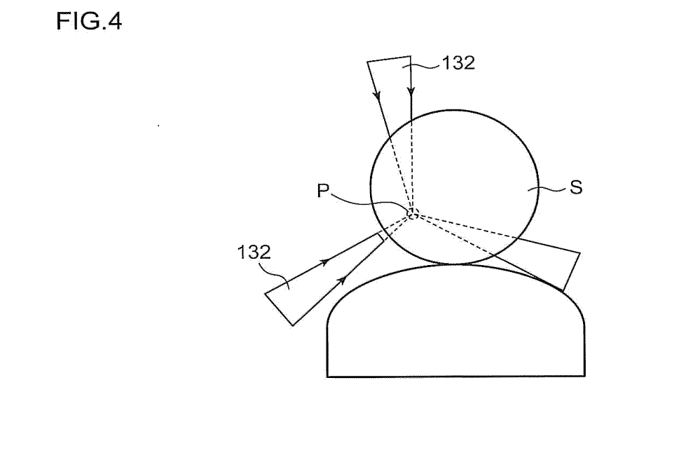

FIG. 4 illustrates a method for estimating the pen-tip position P from the radiated light picked up by the camera. As described above, the camera 30 is so arranged that almost entire screen 110 can be contained within the field of view of the camera 30. Thus, there may occur cases where the pen-shaped device 120 is hidden behind the shadow of the user S and therefore the tip of the pen-shaped device 120 cannot be captured. Even if the image of the tip of the pen-shaped device 120 cannot be captured, the projection-type display apparatus 80 according to the first embodiment can estimate the pen-tip position P by the use of long-and-thin radiated light contained in the captured image.

As shown in FIG. 4, assume herein that the pen-tip position P is behind the shadow of the user S and the pen-tip position P cannot be observed from the camera 30. Then, the projection-type display apparatus 80 detects the radiated light 132 from the captured image. Further, the projection-type display apparatus 80 detects two line segments extending radially with the pen-tip position P as the center, from among the line segments constituting the outline of the radiated light 132. Then the projection-type display apparatus 80 estimates a point that intersects when these two line extend in the captured image, as the pen-tip position P. As described above, the pen-tip position P and the light-emitting element 124 are disposed coaxially with each other, so that the pen-tip position P can be obtained by evaluating the direction where the radiated light is radiated.

If at least two line segments extending radially are detected out of the outer shapes of three distinct radiated light rays 132, the above-described method can be employed. That is, the intersection point of two line segments constituting the outline of a single radiated light ray 132 may be used or the intersection point of a line segment constituting the outline of a first radiated light ray 132 and a line segment constituting the outline of a second radiated light ray 132 may be used. Thus, even through the most of radiated light rays are hidden behind the shadow of the user S, the pen-tip position P can be estimated.

If a plurality of radiated light rays 132 are detected in the captured image, the pen-tip position P may be estimated by the use of any one of the plurality of radiated light rays 132 detected. Alternatively, the pen-tip position P may be estimated for each of the plurality of radiated light rays 132 detected. In the latter case, an average value of the pen-tip positions P estimated for the respective radiated rays 132 may be used.

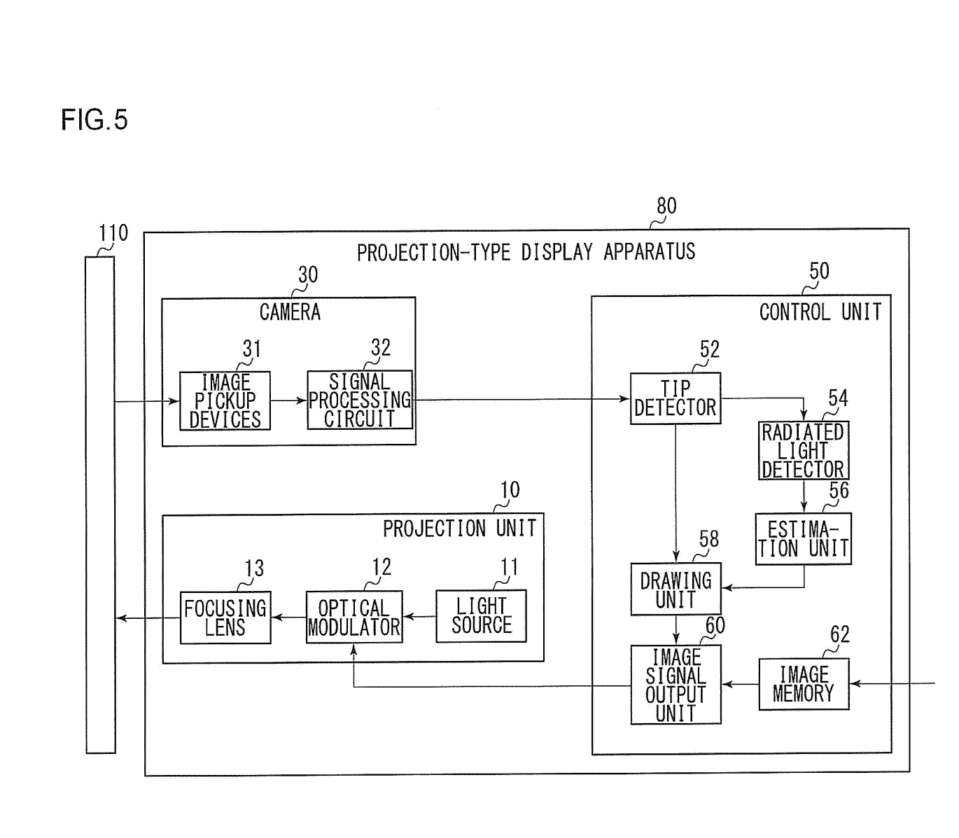

FIG. 5 is a diagram showing a structure of the projection-type display apparatus 80 according to the first embodiment. The projection-type display apparatus 80 mainly includes a projection unit 10, a camera 30, and a control apparatus 50. The control apparatus 50 includes a tip detector 52, a radiated light detector 54, an estimation unit 56, a drawing unit 58, an image signal output unit 60, and an image memory 62.

These structural components of the control apparatus 50 may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

The projection unit 10 projects images onto the screen 110. The projection unit 10 includes a light source 11, an optical modulator 12, and a focusing lens 13. A halogen lamp, a metal halide lamp, a xenon short-arc lamp, a high-pressure mercury lamp, an LED lamp or the like is used for the light source 11. The halogen lamp has a filament type electrode structure, and the metal halide lamp has an electrode structure that generates the arc discharge.

The optical modulator 12 modulates light entering from the light source 11 in response to image signals set from the image signal output unit 60. For example, a digital micromirror device (DMD) is used for the optical modulator 12. The DMD, which is equipped with a plurality of miromirrors corresponding to the number of pixels, forms a desired image in such manner that the orientation of each micromirror is controlled according to each pixel signal.

The focusing lens 13 adjusts the focus position of light entering from the optical modulator 12. The image light generated by the optical modulator 12 is projected onto the screen 110 through the focusing lens 13.

The camera 30 picks up images of the screen 110, images projected onto the screen 110 by the projection unit 10, and images of the pen-shaped device 120 as main objects. The camera 30 includes solid-state image sensing devices 31 and a signal processing circuit 32. The solid-state image sensing devices 31 that can be used are CMOS (Complementary Metal Oxide Semiconductor) image sensors or CCD (Charge-Coupled Devices) image sensors, for instance. The signal processing circuit 32 performs various signal processings, such as A/D conversion and conversion from RGB format to YUV format, on the signals outputted from the solid-state image sensing devices 31 and outputs the processing results to the control apparatus 50.

The tip detector 52 detects the tip of the pen-shaped device 120 from the images captured by the camera 30.

The detection of the tip of the pen-shaped device 120 is achieved by the use of a known technique such as template matching. Alternatively, the arrangement may be such that a light-emitting element is so built into the switch 122 of the pen-shaped device 120 that the switch itself lights up when the tip of the switch 122 is pressed against the screen. In this case, the tip detector 52 detects the luminous point of the tip of the pen-shaped device 120 from the images captured by the camera 30.

If the tip of the pen-shaped device 120 can be detected from the captured images, the tip detector 52 will determine the coordinates of the pen-tip position P within a projection image region. This information on the coordinates thereof is transmitted to the drawing unit 58.

If the tip of the pen-shaped device 120 cannot be detected from the captured images, the radiated light detector 54 will detect the radiated light 132 of an approximately trapezoidal shape from within the captured images. The detection of the radiated light 132 of an approximately trapezoidal shape can also be achieved by the use of a technique such as template matching.

The estimation unit 56 identifies the outer shape of the radiated light 132 detected by the radiated light detector 54 and further detects at least two line segments extending radially. Then, the estimation unit 56 extends these two line segments within the captured image, and estimates the intersection of the extended segments as the tip of the pen-shape device 120. The estimation unit 56 determines the coordinates of the pen-tip position P within the projection image region, and outputs the thus determined coordinates thereof to the drawing unit 58.

The drawing unit 58 continuously joins together the coordinates of the pen-tip position P received, per captured image, from the dip detector 52 or the estimation unit 56 so as to identify the locus of the tip of the pen-shaped device 120. Then the drawing unit 58 produces an image where lines having characteristic features predetermined for the identified locus are drawn. Here, the characteristic features include color, thickness, line type, and so forth.

The image memory 62 stores image data to be projected onto the screen 110. The image data is supplied from an external apparatus, such as a personal computer (PC), via a not-shown interface. The image signal output unit 60 combines image signals, based on the image data stored in the image memory 62, and an image produced by the drawing unit 58, and then outputs the thus combined image to the optical modulator 12. As a result, the image where the lines drawn by the user S is added to the image signals is projected and displayed on the screen 110. Note here that the image signal output unit 60 may not output the image signals supplied from the image memory 62 but output only the images of loci.

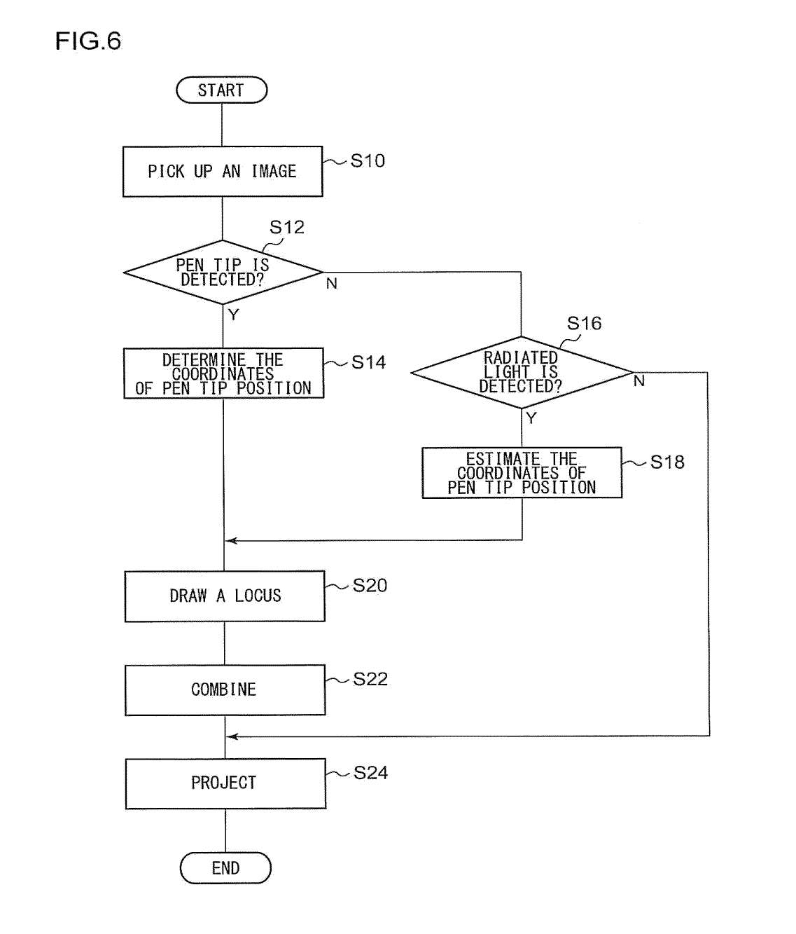

FIG. 6 is a flowchart of a process for drawing a locus on a screen by a pen-shaped device in the projection display system 100.

First, the camera 30 captures an image of a projection image region on the screen (S10). The tip detector 52 attempts to detect the tip of the pen-shaped device within the image captured by the camera 30 (S12). If the tip of the pen-shaped device is detected (Y of S12), the tip detector 52 will determine the coordinates of the pen-tip position in the projection region (S14). If the tip thereof is not detected (N of S12), the radiated light detector 54 will attempt to detect the radiated light within the captured image (S16). If the radiated light is not detected (N of S16), it is considered that the pen-shaped device is not in contact with the screen and therefore no drawing image will be produced and then the procedure will proceed to Step S24. If the radiated light is detected (Y of S16), the estimation unit 56 will estimate the coordinates of the pen-tip position based on at least two line segments constituting the outline of the radiated light (S18).

The drawing unit 58 produces an image, where the locus of the pen-shaped device is drawn, based on the pen-tip coordinates determined by the tip detector 52 or the estimation unit 56 (S20). The image signal output unit 60 combines a locus image with the image signal fed from the image memory 62 (S22), and projects the thus combined image onto the screen by the projection unit 10 (S24).

As described above, by employing the first embodiment, the pen-tip position of the pen-shaped device is estimated by utilizing the radiated light that escapes from a plurality of slits formed in the enclosure of the pen-shaped device. The light rays that have escaped from the slits radiate on the screen and therefore at least part of the radiated light rays is captured by the camera in the event that the tip of the pen-shaped device is hidden by the user as viewed from the camera. Thus, the pen-tip position of the pen-shaped device can be estimated.

In addition, a plurality of slits are provided in a circumferential direction of the pen-shaped device. Thus a situation where the image of the radiated light cannot be picked up depending on the orientation of the pen-shaped device or an angle thereof relative to the screen can be avoided. Further, estimating the pen-tip position using a plurality of light rays allows the detection accuracy to increase.

A description is now given of a modification to the first embodiment.

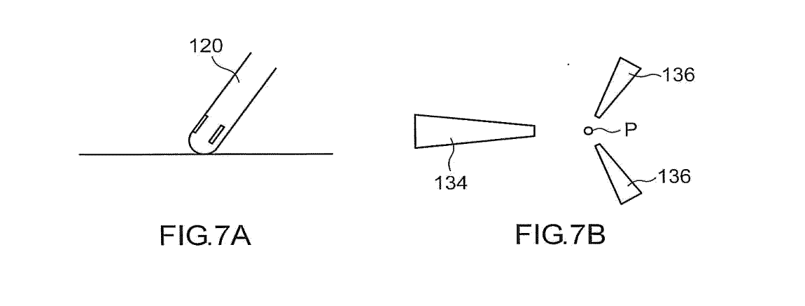

FIGS. 7A and 7B each explains a method for estimating the inclination of the pen-shaped device 120 relative to the screen plane by the use of the pen-shaped device 120. When the pen-shaped device 120 comes in contact with the screen plane by inclining the pen-shaped device 120 relative to the screen plane as illustrated in FIG. 7A, the radiated light 136 becomes smaller along a direction, where the pen-shaped device 120 is inclined, as illustrated in FIG. 7B, and becomes larger in the opposite direction. Thus, the estimation unit can estimate the inclination angle and the orientation of the pen-shaped device, based on a comparison made between the radiated light formed when the pen-shaped device is vertically pressed against the screen and the radiated light detected from the captured image. For example, reference patterns in response to angles formed between the pen-shaped device and the screen may be stored in the projection-type display apparatus, and the projection-type display apparatus may estimate the angle based on a matching result between a reference pattern and the radiated light detected from the captured image.

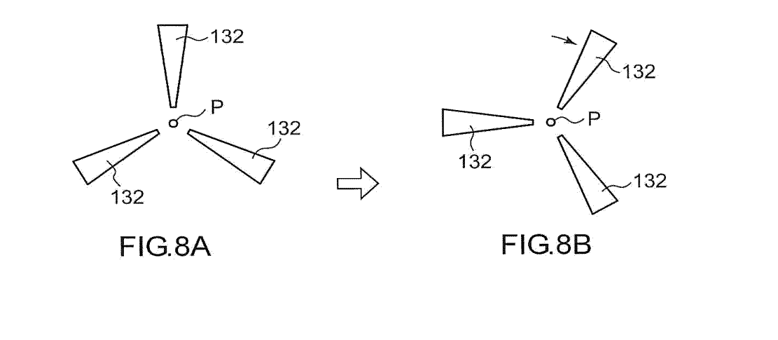

FIGS. 8A and 8B each explains a method for detecting the rotation of the pen-shaped device 120 by the use of the pen-shaped device 120. If the estimation unit identifies that the radiated light 132 has changed from FIG. 8A to FIG. 8B without changing the pen-tip position P as a result of comparison between frames captured by the camera 30, the rotation of the pen-shaped device can be detected.

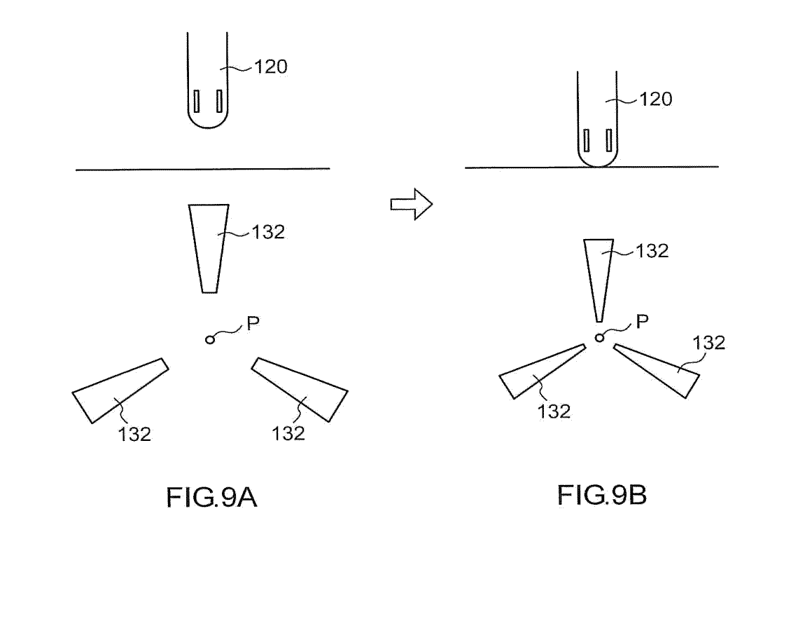

FIGS. 9A and 9B each explains a method for estimating the distance of the pen-shaped device 120 relative to the screen plane by the use of the pen-shaped device 120. Assume, in this example, that the light-emitting element 124 in the pen-shaped device constantly lights up regardless of the switch 122. As shown in FIG. 9A, when the pen-shaped device 120 is spaced apart from the screen plane, the radiated light rays 132 formed on the screen are spaced apart from the pen-tip position P as well. As shown in FIG. 9B, when the pen-shaped device 120 comes in contact with the screen plane, the radiated light rays 132 formed on the screen approach and are located closer to the pen-tip position P. Thus, a table or calculation formula is prepared beforehand where the distances between the pen-tip position P and the tip of the radiated light rays 132 in a captured image are associated with the distance between the actual screen and the pen-shaped device. Based on this table or calculation formula, the estimation unit can estimate the distance between the screen and the pen-shaped device.

As described above in conjunction with FIG. 7A to FIG. 9B, the inclination, rotation and distance of the pen-shaped device 120 are obtained, so that the operations other than the drawing by the pen-shaped device can be used as inputs to the external apparatus such as PC. For example, an approaching operation by the pen-shaped device toward the screen may be associated with the click operation of a mouse, or the inclination of the pen-shaped device which is greater than a predetermined angle may be associated with a move along an inclined angle of a selected object. The rotation of the pen-shaped device may be associated with the rotation of the selected object.

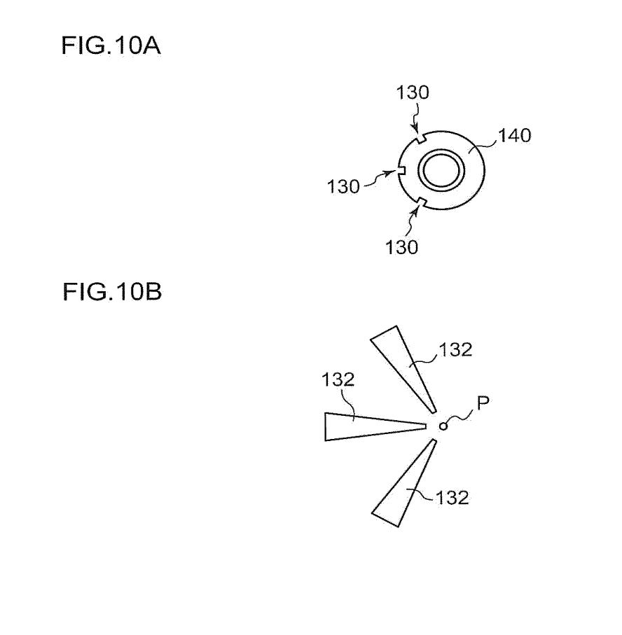

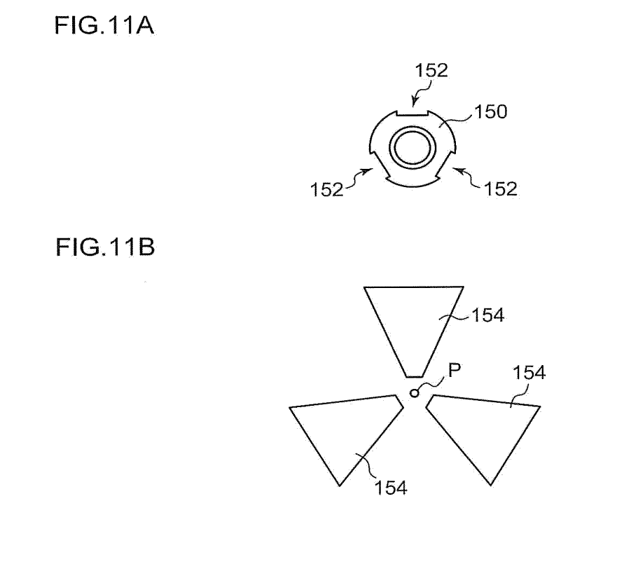

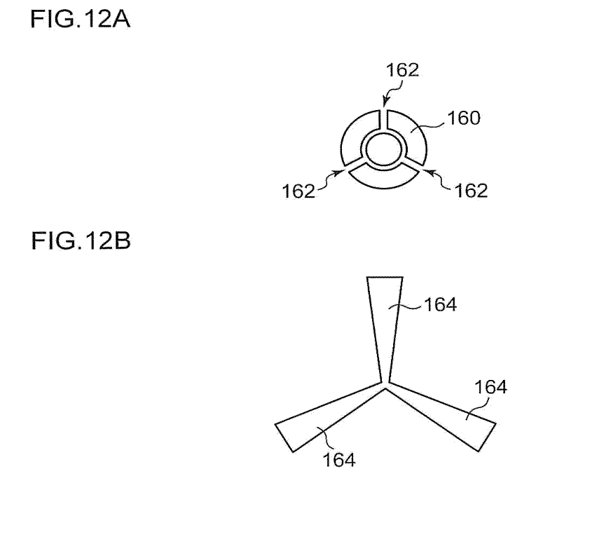

FIG. 10A to FIG. 12B illustrate modifications of slit shape formed in the enclosure of the pen-shaped device. FIG. 10A, FIG. 11A and FIG. 12A each shows an end view of a pen-shaped device as observed from the tip thereof whereas FIG. 10B, FIG. 11B and FIG. 12B each shows a shape of the radiated light rays formed on the screen when the pen-shaped device is in contact with the screen vertically.

FIG. 10A shows a pen-shaped device 140 for which the positions of slits 130 are asymmetrical. In this example, three slots are positioned to the left of the central line. Thus, as shown in FIG. 10B, the radiated light rays on the screen extends to the left of the pen-tip position, too. The user holds the pen-shaped device 140 with a side thereof having no slits facing the palm, so that the light that has escaped from the slits 130 is less likely to be shielded by the hand of the user. Hence, the radiated light is more likely to be detected by the camera.

FIG. 11A shows a pen-shaped device 150 for which the width of each slit 152 is enlarged as compared with the above-described embodiment. As shown in FIG. 11B, the radiated light rays formed on the screen by the pen-shaped device 150 are nearly fan-shaped. With this shape, the angle formed between two line segments of the radiated light extending radially is larger. Thus the detection accuracy of the pen-tip position is expected to improve.

FIG. 12A shows a pen-shaped device 160 whose slits 162 extend to the tip of the pen-shaped device. As shown in FIG. 12B, the radiated light formed on the screen by the pen-shaped device 160 is three-piece shaped where the three pieces are connected in the center.

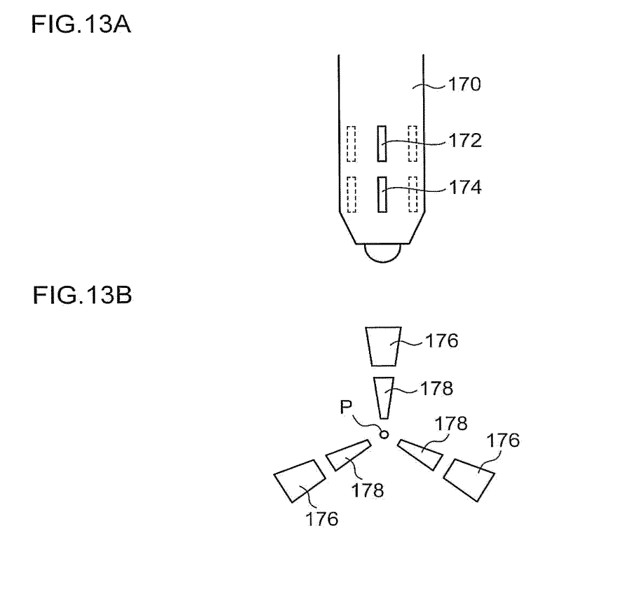

FIG. 13A shows a pen-shaped device 170 having an increased number of slits formed in the enclosure. Similar to the slits of the pen-shaped device 120 shown in FIG. 2, slits 172 are formed equally spaced apart from each other in a circumferential direction but each slit is divided in two in the axial direction. FIG. 13B shows the shapes of radiated light rays formed on the screen by the pen-shaped device 170 wherein the shapes include two kinds of radiated light 176 and radiated light 178. With this arrangement, the amount of information used to estimate the pen-tip position increases and therefore the accuracy with which to estimate the pen-tip position and the inclination of the pen-tip position is expected to improve.

If two or more users are to write letters or draw diagrams on a single screen, each user may use a pen-shaped device having a different slit form. By employing this arrangement, each radiated light shape used by each user differs on the screen and therefore the pen-tip position for each user can be distinguished by the processing performed by the projection-type apparatus. Hence, an image drawn with lines of different characteristic features (color, thickness, line type and so forth) for each user can be projected.

The shape, position and the number of slits are not particularly limited to the above-described ones, and arbitrary shape, position and number of slits may be selected as appropriate, as long as the pen-tip position can be estimated from the radiated light shape captured by the camera. If the radiated light radiates with the tip of the pen-shaped device as the center, the shape of the radiated light may not be trapezoidal or fan-like. Also, a device other than the pen-shaped device may be used as a pointing device as long as the shape, position and the number of slits are selected appropriately.

In addition to the slits, mirrors, prisms, lenses or the like may be used to form the radiated light rays. The slits may not be used at all and instead a light-emitting element or elements may be installed on side surface of the enclosure of the pen-shaped device so as to irradiate the radiated light directly.

### Second Embodiment

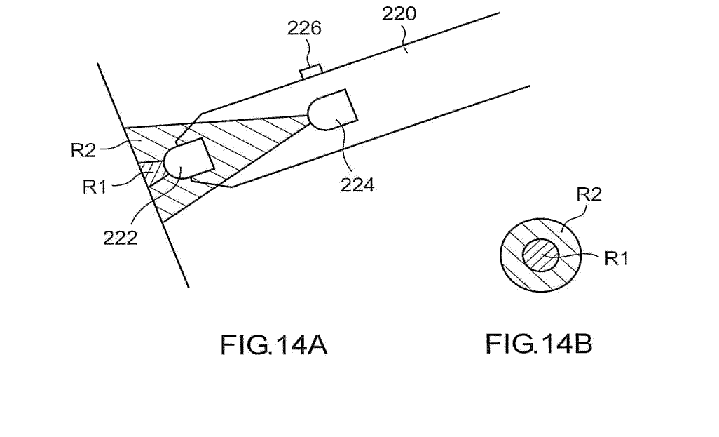

FIG. 14A is a cross-sectional view of a pen-shaped device 220, used together with a projection-type display apparatus, according to a second embodiment of the present invention. Two light-emitting elements 222 and 224 are provided in this pen-shaped device 220. The first light-emitting element 222 is placed on the tip of the pen-shaped device 220, and forms an irradiation region R1 formed on the screen. The first light-emitting element 222 constantly lights up while in use. In contrast to this, the second light-emitting element 224 is switched on and off by a switch 226 placed on a side surface of the enclosure of the pen-shaped device 220. The second light-emitting element 224 is placed posterior to the first light-emitting element 222. As shown in FIG. 14B, the second light-emitting element 222 forms an irradiation region R2 in such a manner as to surround the irradiation region R1 formed by the first light-emitting element 222.

The first irradiation region R1 is used to detect the pen-tip position of the pen-type device. On the other hand, the second irradiation region R2 is used to determine if the switch 226 is pressed or not in the pen-shaped device 220.

It is preferable that the first light-emitting element and the second light emitting element differ in color to facilitate the identification therebetween. However, even if the first light-emitting element and the second light emitting element have the same color, it is still feasible to identify them based on the luminance difference between the irradiation regions R1 and R2.

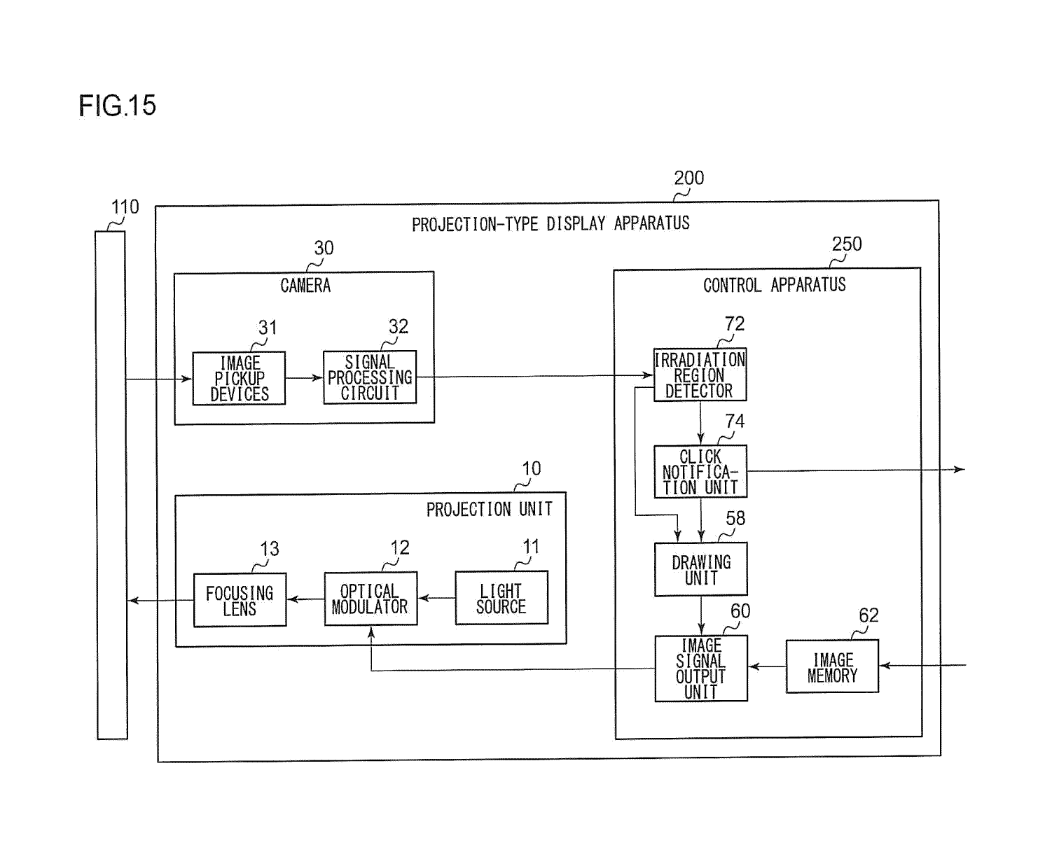

FIG. 15 is a diagram showing a structure of a projection-type display apparatus 200 according to the second embodiment. The projection-type display apparatus 200 mainly includes a projection unit 10, a camera 30, and a control apparatus 250. The projection unit 10 and the camera 30 have the same functions as those of the projection-type display apparatus 80 shown in FIG. 5 and therefore the repeated description thereof is omitted here.

The control unit 250 includes an irradiation region detector 72, a click notification unit 74, a drawing unit 58, an image signal output unit 60, and an image memory 62. The functional blocks of the control apparatus 250 may also be implemented by a variety of manners including hardware only, software only or a combination of both.

The irradiation region detector 72 detects the irradiation regions R1 and R2 from within an image captured by the camera. The detection of the irradiation regions R1 and R2 can be achieved by detecting portions, in the captured image, corresponding to the colors or luminance of the first and second light-emitting elements and the size of an irradiation region formed when the pen-shaped device is in contact with the screen. Once the irradiation region R1 is detected, the irradiation region detector 72 identifies, as the pen-tip position, the coordinates of the detected irradiation region R1 in the captured image and then outputs the thus identified coordinates thereof to the drawing unit 58.

When the irradiation region R2 is detected by the irradiation region detector 72, the click notification unit 74 coveys to an external apparatus such as PC that the switch 226 has been pressed. Preferably, the switch 226 corresponds to a right click on a commonly-used mouse.

The drawing unit 58 produces an image where lines having predetermined characteristic features (color, thickness, line type and so forth) are rendered on the coordinates of the pen-tip position P received from the irradiation region detector 72.

The functions of the image signal output unit 60 and the image memory 62 are similar to those in the projection-type display apparatus 80 shown in FIG. 5 and therefore the repeated description thereof is omitted here.

As described above, according to the projection-type display apparatus of the second embodiment, two light-emitting elements are provided in the pen-shaped device. One of the two light-emitting elements is used to detect the pen-tip position. The other thereof is turned on and off according to the click operation of the mouse. The irradiation regions formed on the screen by the two light-emitting elements are captured by the camera, so that the detection of the pen-tip position and right-click detection can be achieved simultaneously.

Since a circular irradiation region is formed in a pen-tip direction, the distortion in a shape when the pen-shaped device is inclined is small. Hence, the inclination of the pen-shaped device relative to the screen does not affect the detection accuracy of the irradiation regions significantly, thereby enabling a stable detection.

In a commonly available projection-type apparatus, a wireless system such as Bluetooth is often used to transmit the click operation in a pointing device. In contrast to this, according to the projection-type display apparatus of the second embodiment, both the pen-tip position and the click operation can be detected by a single camera. Thus the structure is far simpler and the overall cost is reduced.

To enable the stable detection of the click operation, detecting the click operation, namely detecting whether or not the irradiation region R2 has been detected may be performed only when the irradiation region R1 is detected. Also, to prevent a false detection of the irradiation region R2, detecting whether or not the irradiation region R2 has been detected may be performed only within a predetermined range with the irradiation R1 as the center.

### Third Embodiment

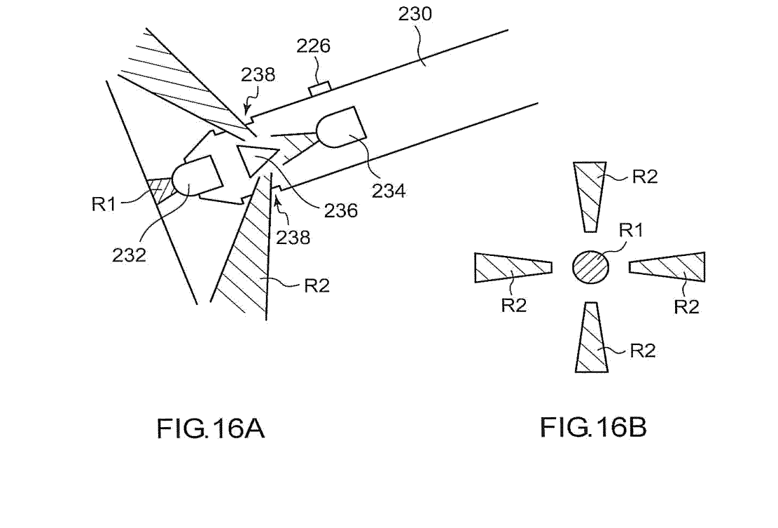

Detecting the pen-tip position using the radiated light from the slits described in the first embodiment and detecting the click operation described in the second embodiment may be performed in combination. FIGS. 16A and 16B are each a cross-sectional view of a pen-shaped device 230 according to such a third embodiment of the present invention where such two detection methods are used in combination.

As shown in FIG. 16A, two light-emitting elements 232 and 234 are provided in this pen-shaped device 230. The first light-emitting element 232 is placed on the tip of the pen-shaped device 230, and irradiates an irradiation region R1 on the screen. The first light-emitting element 232 is switched on and off by a switch 226 placed on a side surface of the enclosure of the pen-shaped device 220. The second light-emitting element 234 is placed posterior to the first light-emitting element 232. The light irradiated from the second light-emitting element 234 is reflected by a mirror or prism placed inside the enclosure, then passes through slits 238 formed on a side surface of the enclosure, and is irradiated on a lateral surface of the pen-shaped device 230. Assume, in this example, that four slits 238 are formed equally spaced apart from each other in a circumferential direction.

FIG. 16B shows the shape of irradiation regions formed on the screen by the pen-shaped device 230. The irradiation region R1 is irradiated with the first light-emitting element 232 only while the switch 226 is being pressed. The irradiation regions R2 are formed by the second light-emitting element 234.

Similar to the second embodiment, the click operation can be detected based on whether or not the irradiation region R1 has been detected from an image of the screen captured by the camera. Similar to the first embodiment, the irradiation region R2 is detected, so that the coordinates of the pen-tip position can be obtained based on the shape of the detected irradiation region R2.

### Fourth Embodiment

As IT progresses in various business fields and technical fields, things done manually so far are now replaced by operations performed by electronic devices. This contributes to a marked improvement in work efficiency and even an achievement which is conventionally not feasible. For example, a set of electronic blackboard and electronic pen allows a very easy storage and erasure of contents written on the board as compared with the conventional set of blackboard and chalk. In a presentation using a large screen, the electronic pen makes it possible to cast the spot light and overwrite characters and symbols on the screen. Before the electronic pens appear on the market, a spot of interest on the board can only be indicated using a stick or the like.

At the same time, there are many people who are not good at or comfortable with handling such electronic devices, and demand for user-friendly interface has been ever greater to enhance the wide spread of the electronic devices.

A fourth embodiment of the present invention has been made in view of the foregoing circumstances, and a purpose thereof is to provide a technology for improving the operability of optical input devices such as electronic pens.

An optical input system according to one mode for carrying out the fourth embodiment includes an image pickup unit and a determining unit. The image pickup unit picks up an image of a luminous body itself in an input device carrying the luminous body and reflected light of light irradiated from the luminous body to a display surface, such as screen or wall. The determining unit compares a barycentric position of light of the luminous body itself with that of the reflected light in an image captured by the image pickup unit, and determines that the input device and the display surface are in contact with each other when the barycentric positions thereof are associated with each other and determines that the input device and the display surface are not in contact with each other when the barycentric positions thereof are not associated with each other.

Another embodiment of the fourth embodiment relates to a projection-type image display apparatus. This apparatus is a projection-type image display apparatus provided with the above-described optical input system, and it includes (1) an interface that outputs coordinates outputted from the optical input system to an image processing apparatus and receives an input of image data after drawing data has been superposed on the coordinates by the image processing apparatus, and (2) a projection unit that projects the image data on the display surface.

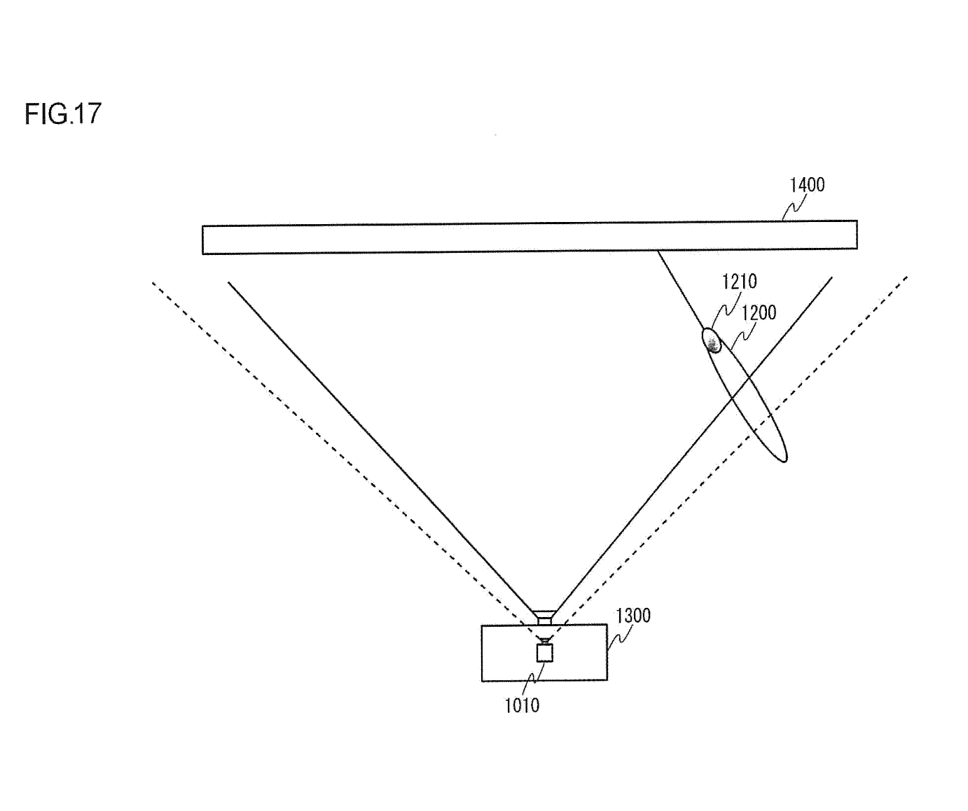

FIG. 17 illustrates an example of the application of the optical input system according to the fourth embodiment of the present invention. In conjunction with FIG. 17, a description is given of an example where the optical input system is applied to a projection-type image display apparatus 1300. The projection-type image display apparatus 1300 is provided with an image pickup unit 1010 for capturing images projected onto a display surface (e.g., screen or wall) 1400. In other words, the optical input system is applied to a so-called projector with a camera. Note that the camera and the projector do not need to be provided integrally with each other and instead may be provided separately. Also, the camera may be installed at any position where it can capture the projector or the screen after the projection or the screen has been installed. The solid lines in FIG. 17 indicate projection light of the projector and irradiation light of an input device 1200, whereas the dotted lines in FIG. 17 indicate a field of view for the camera.

The input device 1200 is provided with a luminous body 1210. In the fourth embodiment, a description is given of an example where the input device 1200 is formed like a pen and the luminous body is fixed to a pen tip of the input device 1200. The user of the input device 1200 can draw or overwrite characters or symbols on the display surface 1400 by irradiating the display surface 1400 with the light emitting from the luminous body 1210. As will be described later, the user can draw the characters, symbols or else regardless of whether the display surface 1400 and the input device 1200 are in contact with each other or not.

Thus, in view of the size of or material used for the display surface 1400 and the distance between the display surface 1400 and the user, the user can enter characters or symbols onto an image displayed on the display surface by having the input device 1200 make contact with the display surface 1400. Also, in view of the size of or material used for the display surface 1400 and the distance between the display surface 1400 and the user, the user can enter the characters or symbols onto the image by the use of the spot light cast from the input device 1200 when he/she moves the input device 1200 in the air. For example, where the display surface 1400 is a screen which is flexible on the surface, the characters or symbols may be entered easily if they are inputted without being in contact with the screen itself.

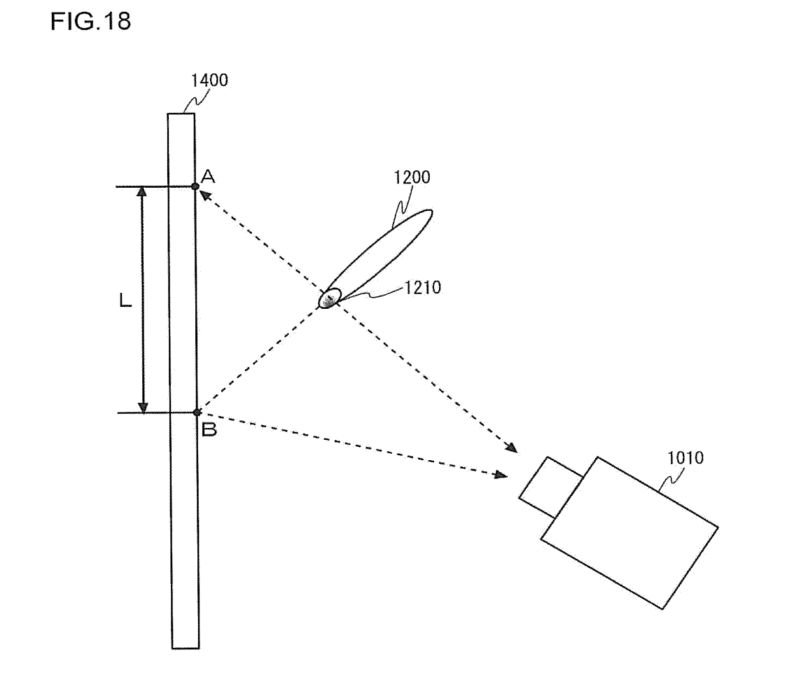

FIG. 18 is a diagram showing the basic principle of the optical input system according to the fourth embodiment. The image pickup unit 1010 captures two light rays which are light A of the luminous body 1210 itself in the input device 1200 (hereinafter referred to as “directly light” or “direct light ray”) and light B reflected from the display surface 1400. If the barycenters of luminance distributions of the direct light A and the reflected light B in a captured image overlap with each other, it will be determined that the tip of the input device 1200 is in contact with the display surface 1400. If the respective barycenters thereof are spaced apart from each other, it will be determined that the tip of the input device 1200 is separated from the display surface 1400. The distance between the tip of the input device 1200 and the display surface 1400 can be estimated from a distance L between the barycenters thereof.

If the distance L meets predetermined conditions, the coordinates outputted from the optical input system to a controller will be the coordinates of the reflected light B. Otherwise, the coordinates outputted from the optical input system to the controller will be the coordinates of the direct light A. The predetermined conditions include a condition that the distance L is greater than a preset distance. In view of the distortion of the screen in the captured image, the preset distance may differ for each coordinates. Further, the predetermined conditions may include a condition that the direct light A exists outside the screen and a condition that the direct light A cannot be detected, for instance.

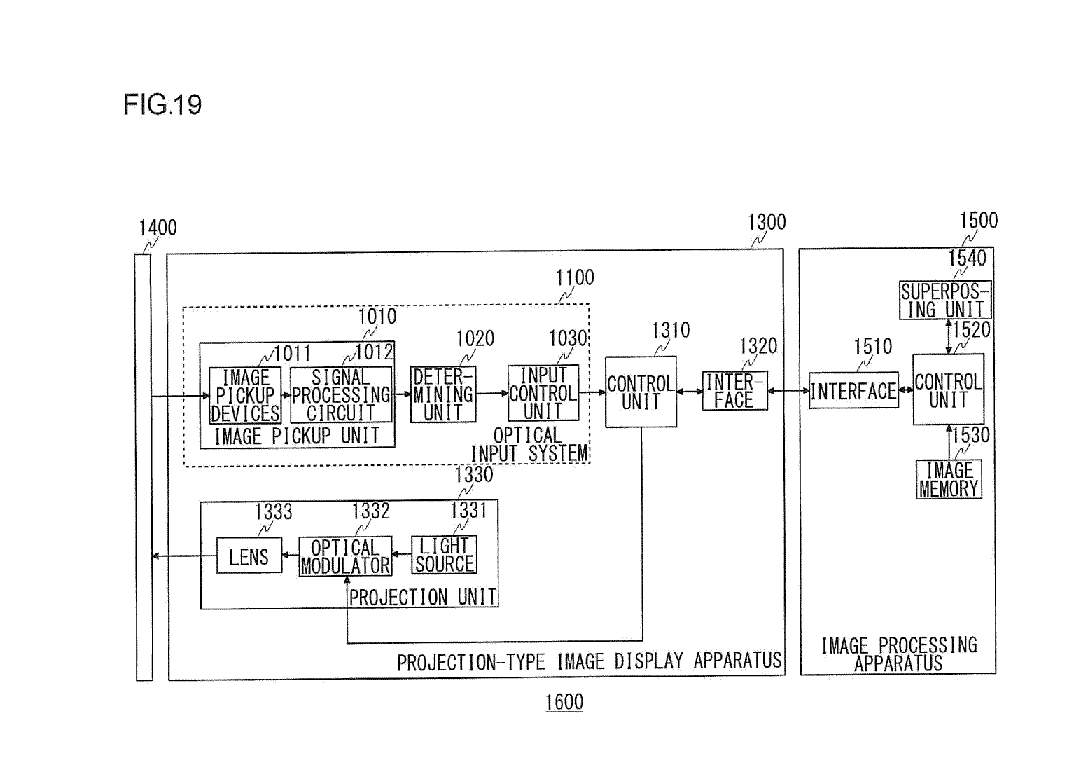

A description is given hereunder of a concrete structure to achieve this basic principle. FIG. 19 is a diagram showing a structure of a projection-type image display system 1600 according to the fourth embodiment. The projection-type image display system 1600, which includes a projection-type image display apparatus 1300 and an image processing apparatus 1500, is so configured that images can be projected onto the display surface 1400. The image processing apparatus 1500, which stores image data and can edit them, corresponds to a PC, an optical disk recorder, a hard disk recorder, or the like.

The projection-type image display apparatus 1300 includes an optical input system 1100, a control unit 1310, an interface 1320, and a projection unit 1330. The optical input system 1100 includes an image pickup unit 1010, a determining unit 1020, and an input control unit 1030. The image processing apparatus 1500 includes an interface 1510, a control unit 1520, an image memory 1530, and a superposing unit 1540.

The image pickup unit 1010 takes images of the direct light of the luminous body 1210 mounted on the input device 1200 and the reflected light of light irradiated to the display surface 1400 from the luminous body 1210. The image pickup unit 1010 includes image pickup devices 1011 and a signal processing circuit 1012. The image pickup devices 1011 that can be used are CMOS (Complementary Metal Oxide Semiconductor) image sensors or CCD (Charge-Coupled Devices) image sensors, for instance. The signal processing circuit 1012 performs various processings, such as A/D conversion and barycentric position detection, on the signals outputted from the image pickup devices 1011 and outputs the thus processing results to the determining unit 1020.

The determining unit 1020 compares the barycentric position of the direct light with that of the reflected light in the image captured by the image pickup unit 1010. If the barycentric position of the direct light and the barycentric position of the reflected light are associated with each other, the determining unit 1020 will determine that the input device 1200 is in contact with the display surface 1400. If the barycentric position of the direct light and that of the reflected light are not associated with each other, the determining unit 1020 will determine that the input device 1200 is not in contact with the display surface 1400. Hereinafter, the state when the input device 1200 and the display surface 1400 are in contact with each other is called a “contact input mode” (or “touch pointing mode”), and the state when the input device 1200 and the display surface 1400 are not in contact with each other is called a “non-contact input mode” (or “touchless pointing mode”).

The “barycentric position of the direct light and the barycentric position of the reflected light are not associated with each other” meant here is either a case where the both barycentric positions thereof agree with each other or a case where the coordinates of the both positions are closer than a first set distance. The determining unit 1020 hands over the decision result to the input control unit 30. If the barycentric position of the direct light and that of the reflected light are closer than the first set distance, the input control unit 1030 will make it valid to draw the characters and symbols. If the barycentric position of the direct light and that of the reflected light are farther than the first set distance and closer than a second set distance mentioned later, the input control unit 1030 will make it invalid to draw the characters and symbols. Identification information (e.g., identification flag) by which to identify whether the drawing is valid or invalid is appended to the coordinates outputted to the controller described later. In this patent specification, the state where the barycentric position of the direct light and that of the reflected light are closer than the first set distance is defined to be an “in-the-process-of-input state” in the touch pointing mode. Similarly, the state where the barycentric position of the direct light and that of the reflected light are farther than the first set distance and closer than the second set distance is defined to be an “input-stop state” in the touch pointing mode.

If the decision result by the determining unit 1020 indicates that the barycentric position of the direct light and that of the reflected light are farther than or equal to the second set distance which is longer than the first set distance, the input control unit 1030 will set the mode to the non-contact input mode. If the decision result by the determining unit 1020 indicates that the barycentric position of the direct light and that of the reflected light are not farther than the second set distance, the input control unit 1030 will set the mode to the contact input mode. The first set distance and the second set distance may be set to values through experiments or simulation runs done by a designer in view of the sensitivity of them. As described above, different distances may be set for each region in a captured image or each coordinates.

If the decision result by the determining unit 1020 indicates that the barycentric position of the direct light and that of the reflected light are farther than or equal to the second set distance, the input control unit 1030 will output the coordinates corresponding to the barycentric position of the reflected light to a controller (i.e., the control unit 1310 in the fourth embodiment). If the decision result by the determining unit 1020 indicates that the barycentric position of the direct light and that of the reflected light are not farther than the second set distance, the input control unit 1030 will output the coordinates corresponding to either one of the barycentric position of the direct light and that of the reflected light to the controller. Since in this case the both the barycentric position of the direct light and that of the reflected light basically agree to each other, either one of them may be used. If they are farther than the first set distance and closer than the second set distance, the state is the input-stop state in the touch pointing mode. Thus, the input control unit 1030 sets the identification information, appended to the output coordinates, to a drawing-disabled state. For example, an identification flag is set to indicate “nonsignificant”.

The control unit 1310 controls the entire projection-type image display apparatus 1300 in a unified manner. In the fourth embodiment, there is provided a function for outputting the coordinates identified by the input control unit 1030 to the interface 1320.

The interface 1320 outputs the coordinates identified by the input control unit 100 to the image processing apparatus 1500. The interface 1510 receives the thus identified coordinates and outputs them to the control unit 1520. The interface 1320 and the interface 1510 are connected via USE (Universal Serial Bus) or HDMI (High-Definition Multimedia Interface).

The image memory 1530 stores image data including still images and moving images. The control unit 1520 controls the entire image processing apparatus in a unified manner. In the fourth embodiment, there is provided a function for controlling the superposing unit 1540 in such a manner as to superpose the drawing data on the coordinates received via the interface 1510. If the identification information is set to the drawing-disabled state, the control unit 1520 will not output a superposition instruction to the superposing unit 1540. The superposing unit 1540 superposes the drawing data on the coordinates of image data to be supplied to the projection-type image display apparatus 1300, according to instructions given from the control unit 1520.

The drawing data is basically dot data of a predetermined color. The number of dots to be drawn may be adjusted according to the thickness (size) of the point of an electronic pen serving as the input device 1200. For example, when the electronic pen's point is relatively large, eight dots surrounding the coordinates may be drawn additionally. Sixteen dots surrounding said eight dots may further be drawn.

The interface 1510 outputs image data after drawing data has been superposed on the coordinates, to the interface 1320, whereas the interface 1320 receives the input of the image data and outputs the received input thereof to the control unit 1310.

The projection unit 1330 the image data to the display surface 1400. The projection unit 1330 includes a light source 1331, an optical modulator 1332, and a lens 1333. A halogen lamp, a metal halide lamp, a xenon short-arc lamp, a high-pressure mercury lamp, an LED lamp or the like is used for the light source 1331. The halogen lamp has a filament type electrode structure, and the metal halide lamp has an electrode structure that generates the arc discharge.

The optical modulator 1332 modulates light entering from the light source 1331 in response to image data set from the control unit 1310. For example, a digital micromirror device (DMD) is used for the optical modulator 1332. The DMD, which is equipped with a plurality of miromirrors corresponding to the number of pixels, forms a desired image in such manner that the orientation of each micromirror is controlled according to each pixel signal. The image light is magnified by the lens 1333 and then projected onto the display surface 1400.

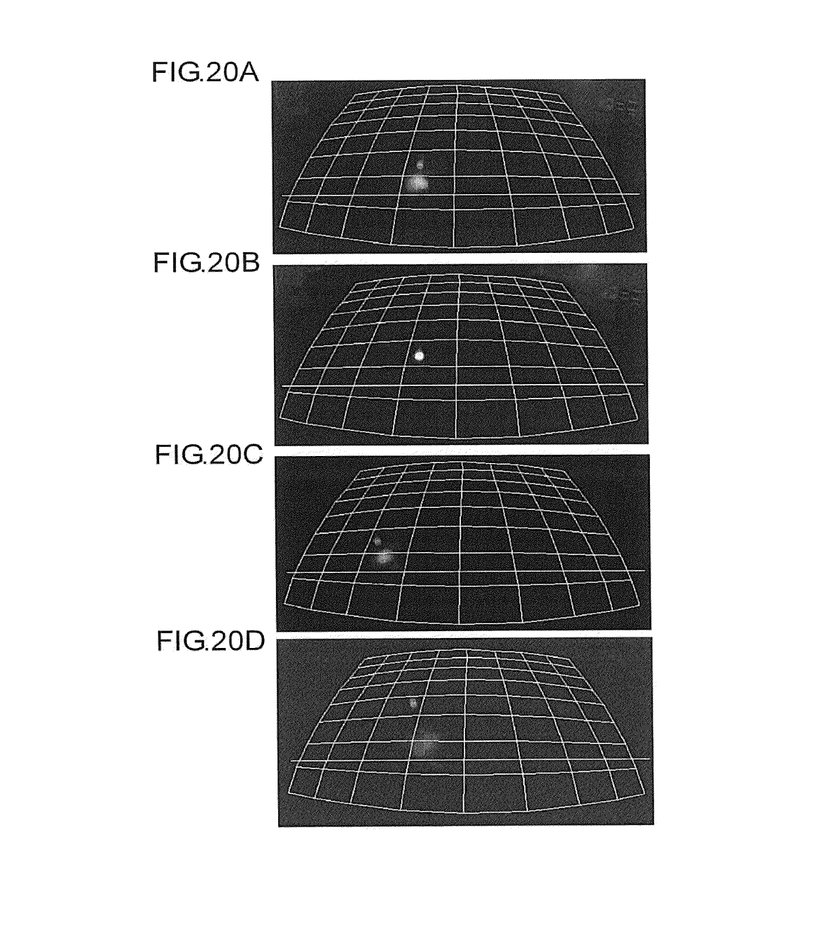

FIG. 20A to FIG. 20D illustrate examples of the direct light and the reflected light captured by the image pickup unit 1010. In FIG. 20A, a smaller light spot in two light spots indicates the direct light, and a larger light spot indicates the reflected light. FIG. 20B shows a state where the barycentric position of the direct light and that of the reflected light agree with each other. In this state, the projection-type image display system 1600 operates in touch pointing mode. FIG. 20C shows a state where the barycentric position of the direct light and that of the reflected light are spaced apart from each other. In this state, the projection-type image display system 1600 operates in touchless pointing mode. FIG. 20D shows a state where the barycentric position of the direct light and that of the reflected light are farther away from each other. This indicates a state where the input device 1200 and the display surface are farther away from each other.

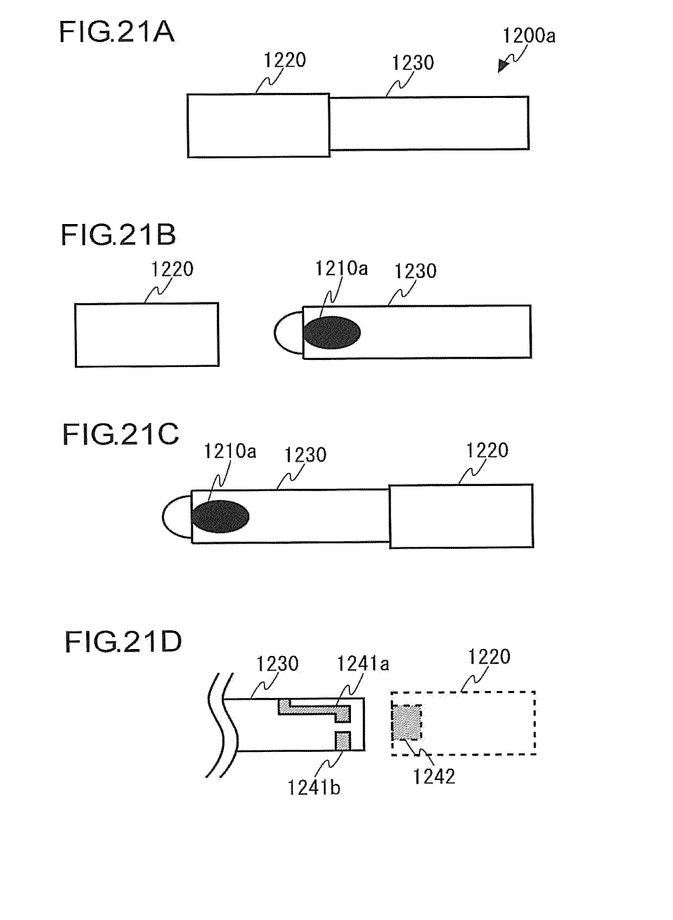

FIG. 21A to FIG. 21D are diagrams showing electronic pens 1200a suitable for use in the optical input system 1100 according to the fourth embodiment. In the electronic pens 1200 shown in FIG. 21A to FIG. 21D, the power supply of each luminous body 1210 (LED 1210a used in FIG. 21A to FIG. 21D) is turned on or off by removing or attaching a cap 1200 to the rear end of the pen.

FIG. 21A shows a state where the tip of the pen is covered by the cap 1220. In this state, the power of the LED 1210a is off. FIG. 21B shows a state where the cap 1220 is removed from the pen tip. In this state, too, the power of the LED 1210a is still off. FIG. 21C shows a state where the rear end of a pen body 1230 is covered by the cap 1220. In this state, the power of the LED 1210a is on.

FIG. 21D shows a principle of how the LED 1210a is turned on and off. On the outside of the pen body 1230, a plus-side wiring pattern 1241a and a minus-side wiring pattern 1241b are formed with a gap provided therebetween. The plus-side wiring pattern 1241a and the minus-side wiring pattern 1241b are connected respectively to a plus terminal and a minus terminal of a battery to light up the LED 1210a. On the inside of the cap 1220, a contact wiring pattern 1242 is formed. As the pen body 1230 is covered by the cap 1220, the plus-side wiring pattern 1241a and the minus-side wiring pattern 1241b conduct with each other through the contact wiring pattern 1242, so that the power of the LED 1210a is turned on and the LED 1210a lights up.

As described above, by employing the fourth embodiment, the direct light and the reflected light are captured by the camera and the state of the electronic pen is systematically detected. Thus, there is no need to control the light emission at the pen tip. Hence, the operability of the electronic pen is enhanced. In other words, the user can draw characters, symbols or else on a displayed image in the similar sense to when an ordinary ink pen or ball-point pen is used, without regard to an operation concerning adjusting the pen pressure of the pen tip, for instance.

Also, both the touch pointing mode in which an input is made while the input device is in contact with the screen and the touchless pointing mode in which an input is made from a position away from the screen can be achieved. Further, these two modes can be automatically switched therebetween.

If the tip of the pen is set slightly apart from the display surface, the drawing can be instantly rendered invalid without turning on or off the switch. This operational feeling is the same as the actual ink pen or ball-point pen.

Also, there is no need to provide a manual switch or pen-pressure sensor, so that the electronic pen can be made at low cost and the size thereof can be made smaller. Thus, the number of pens used can be increased easily and an operational environment much similar to the actual ink pen can be provided. For example, a set comprising a plurality of electronic pens each having a different color to be entered may be put on the market.

Also, with the electronic pen configured as in FIG. 21A to FIG. 21D, the light emission can be controlled by attaching and removing the cap similarly to when handling the ink pen. This also gives the same operational feeling as that gained by the actual ink pen or ball-point pen. That is, the pen becomes usable when the pen is covered by the cap in the real end of the pen, whereas it becomes not usable when the pen is covered by the cap on the tip of the pen.

### Fifth Embodiment

There may arise the following problem of reduced work efficiency in the projection-type display system capable of detecting the locus of the pointing device on the screen and capable of drawing the locus thereof during the projection of images. That is, when a menu screen used to change the setting of the pointing device is to be displayed and then a menu is to be selected, the user may have to extend or move his/her arm to an edge of the screen and therefore the work efficiency may drop.

A fifth embodiment of the present invention has been made in view of the foregoing circumstances, and a purpose thereof is to provide a technology for changing the setting of the pointing device within arm's reach while the user is drawing, in the information display system that detects and displays the locus of the pointing device.

One mode for carrying out the fifth embodiment relates to a program, embedded in a non-transitory computer-readable medium and executable by a control apparatus, in the information display system that includes the control apparatus for detecting the locus of indication point relative to a predetermined plane. The program includes: a detecting module operative to detect the coordinates of the indication point from an image where a region containing the indication point on the predetermined plane is captured; a drawing module operative to draw the locus of the indication point and produce an image where a predetermined icon is drawn near the indication point; and an outputting module operative to output the produced image to an image display apparatus.

Another mode for carrying out the fifth embodiment relates to an information display system including a control apparatus for detecting the locus of indication point relative to a predetermined plane. The control apparatus includes: a detector that detects the coordinates of the indication point from an image where a region containing the indication point on the predetermined plane is captured; a drawing unit that draws the locus of the indication point and produces an image where a predetermined icon is drawn near the indication point; and an output unit that outputs the produced image to the image display apparatus.

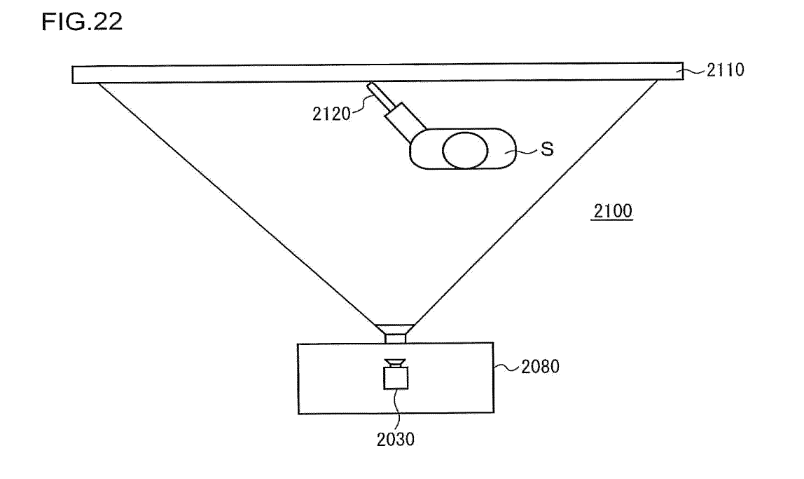

FIG. 22 illustrates a general structure of a projection display system 2100 according to the fifth embodiment. The projection display system 2100 includes a projection-type display apparatus 2080 (hereinafter referred to as “projector” also), a screen 2110 onto which images are projected from the projection-type display apparatus 2080, and a pointing device 2120 operated by the user S. The projection-type display apparatus 2080 includes a camera 2030 for taking images toward and along the screen 2110. For example, the camera 2030 is installed so that the optical center of the camera 2030 can be set parallel to the optical center of projection light projected from the projection-type display apparatus 2080.

In the first embodiment, the user S operates to draw lines and characters by moving the pointing device 2120 in such a manner that the pen-shaped pointing device 2120 is in contact with the projection plane of the screen 2110. The projection-type display apparatus 2080 detects the locus of indication point of the pointing device 2120, based on images captured by the camera 2030. Then the projection-type display apparatus 2080 produces an image where the locus has been drawn and then projects the image onto the screen 2110.

The camera 2030 is arranged so that almost entire screen 2110 can be contained within the field of view of the camera 2030 in order for the camera 2030 to take the images of the movement of the pointing device 2120 on a projected image. As shown in FIG. 22, the screen 2110 and the camera 2030 are preferably positioned such that the camera 2030 is located right in front of the screen 2110. However, the camera 2030 may be placed off horizontally from the projection-type display apparatus 2080. Alternatively, the camera 2030 may be placed nearer the screen than the projection-type display apparatus 2080. Also, a plurality of cameras 2030 may be used.

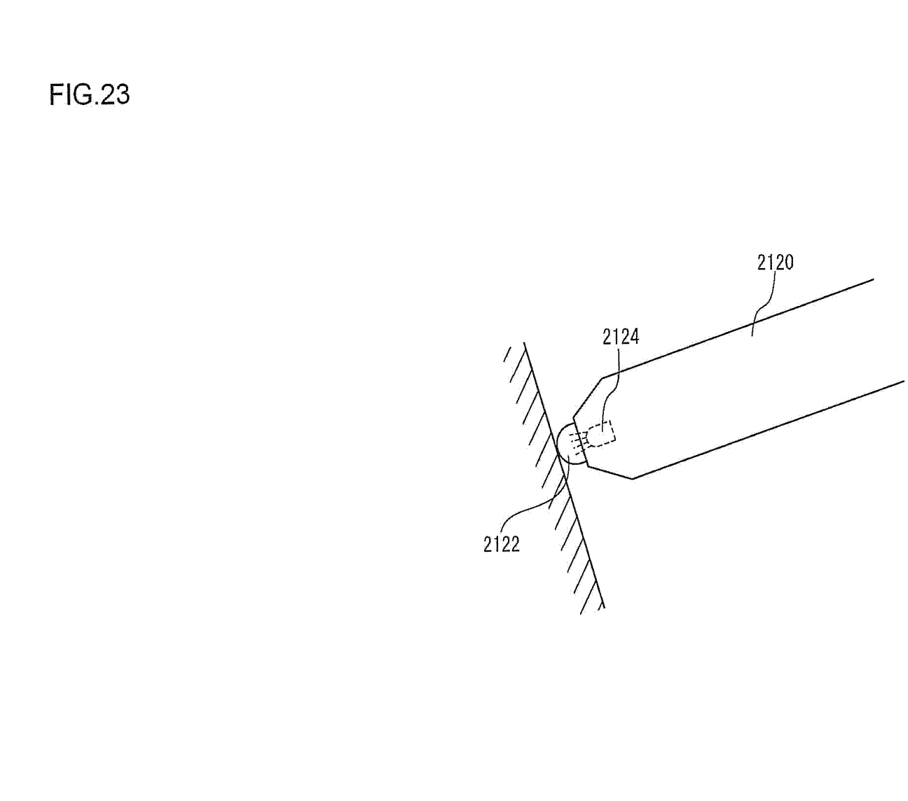

FIG. 23 illustrates a structure of the pen-shaped pointing device (hereinafter referred to simply as “pen-shaped device”) 2120 according to the first embodiment. An operation of the pen-shaped device 2120 being pressed against and moved along the projection plane of the screen is detected while the user holds it in the same manner as a regular ball-point pen or the like. In FIG. 23, the solid line indicates the outer shape of the pen-shaped device 2120, whereas the dotted line indicates the internal structure thereof.

A switch 2122 having a semispherical tip part is mounted on the tip of the pen-shaped device 2120. The switch 2122 is formed of transparent or translucent material. A light-emitting element 2124, such as an LED (Light Emitting Diode), to which the power is supplied from a not-shown battery, is provided in an enclosure of an approximately cylindrical form. A configuration is such that when the user continues to press the tip of the pen-shaped device 2120 against the screen 2110, the switch 2122 is pressed inwardly, thereby the light-emitting element 2124 lights up, the screen is irradiated with the light through the switch 2122 and then the irradiated light becomes the indication point of the pen-shaped device 2120.

It is preferable that the central axis of the pen-shaped device 2120, the contact point of the switch 2122 to the screen, and the light emission center of the light-emitting element 2124 are disposed coaxially to each other. The shape of the enclosure of the pen-shaped device 2120 is not limited to the cylindrical form only and may be of arbitrary shapes. The illumination intensity and color of the light-emitting element 2124 are selected to the degree the radiated light can be recognized in a captured image on the screen in an assumed use environment of the projection-type display apparatus 2080.

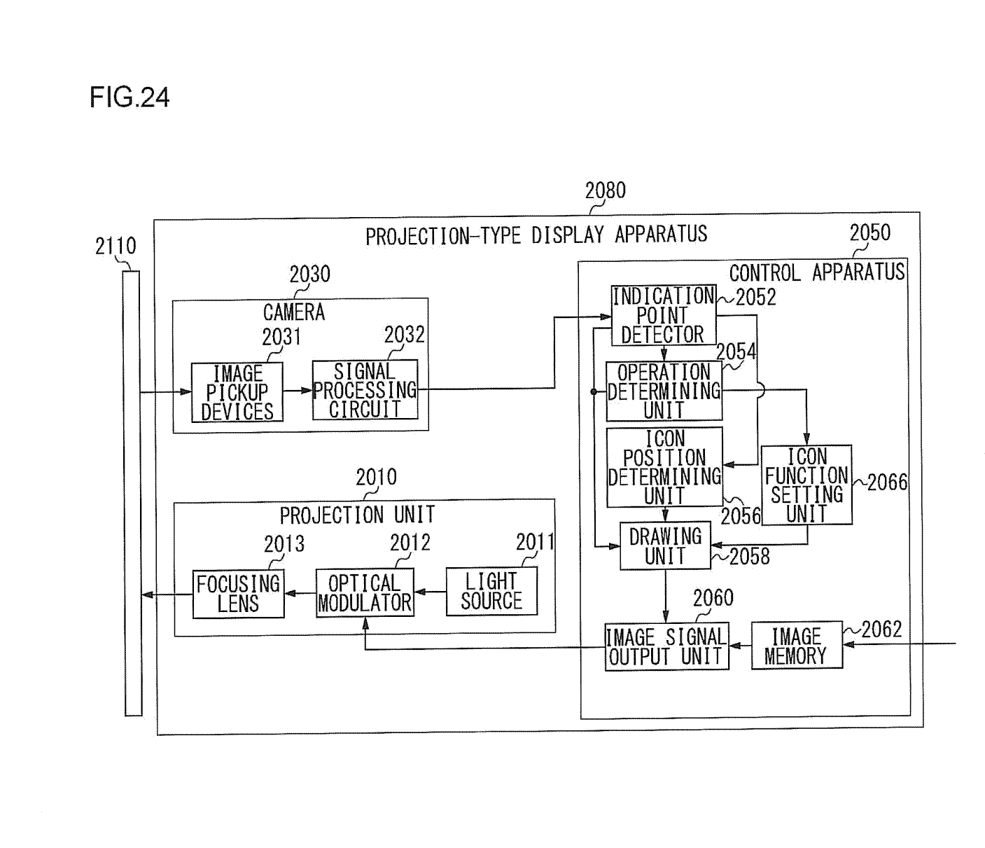

FIG. 24 is a diagram showing a structure of the projection-type display apparatus 2080 according to the fifth embodiment. The projection-type display apparatus 2080 mainly includes a projection unit 2010, a camera 2030, and a control apparatus 2050. The control apparatus 2050 includes an indication point detector 2052, an operation determining unit 2054, an icon position determining unit 2056, a drawing unit 2058, an image signal output unit 2060, an image memory 2062, and an icon function setting unit 2066.

These structural components of the control apparatus 2050 may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

The projection unit 2010 projects images onto the screen 110. The projection unit 2010 includes a light source 2011, an optical modulator 2012, and a focusing lens 2013. A halogen lamp, a metal halide lamp, a xenon short-arc lamp, a high-pressure mercury lamp, an LED lamp or the like is used for the light source 2011. The halogen lamp has a filament type electrode structure, and the metal halide lamp has an electrode structure that generates the arc discharge.

The optical modulator 2012 modulates light entering from the light source 2011 in response to image signals set from the image signal output unit 2060. For example, a digital micromirror device (DMD) is used for the optical modulator 2012. The DMD, which is equipped with a plurality of miromirrors corresponding to the number of pixels, forms a desired image in such manner that the orientation of each micromirror is controlled according to each pixel signal.

The focusing lens 2013 adjusts the focus position of light entering from the optical modulator 2012. The image light generated by the optical modulator 2012 is projected onto the screen 2110 through the focusing lens 2013.

The camera 2030 picks up images of the screen 2110, images projected onto the screen 2110 by the projection unit 2010, and images of the pen-shaped device 2120 as main objects. The camera 2030 includes solid-state image sensing devices 2031 and a signal processing circuit 2032. The solid-state image sensing devices 2031 that can be used are CMOS (Complementary Metal Oxide Semiconductor) image sensors or CCD (Charge-Coupled Devices) image sensors, for instance. The signal processing circuit 2032 performs various signal processings, such as A/D conversion and conversion from RGB format to YUV format, on the signals outputted from the solid-state image sensing devices 2031 and outputs the processing results to the control apparatus 2050.

The indication point detector 2052 detects a bright point of light irradiated from the tip of the pen-shaped device 2120, from an image captured by the camera 2030 and then identifies the coordinates of the pen-tip position that serves as the indication point in a projected image. This coordinate information is sent to the operation determining unit 2054 and the drawing unit 2058.

The operation determining unit 2054 determines if there is any of click, drag and drop operations over a predetermined icon or menu item displayed within a projected image. The predetermined icon is used to change the setting of the pen-shaped device, and includes a menu icon and a toggle switch icon both described later, for instance. The menu item is an item corresponding to each function in a menu image described later.

The operation determining unit 2054 compares the coordinates of a predetermined icon or menu item with the coordinates of the tip of the pen-shaped device. Then, if the tip of the pen-shaped device is positioned within a predetermined icon or menu item, it will be determined that a click is performed. If the tip of the pen-shaped device continues to stay within an icon for a predetermined time length or longer, it will be determined that a drag operation is performed. If the tip thereof is separated away from the screen, it will be determined that a drop operation is performed. This operation information is supplied to the icon position determining unit 2056 and the drawing unit 2058.

The icon position determining unit 2056 determines a position, in which a predetermined icon is to be displayed, near the position of pen-tip coordinates identified by the indication point detector 2052. It is preferable that the icon, which follows the movement of the tip of the pen-shaped device, be displayed in such a position as not to interfere with the drawing by the user. Thus, the icon position determining unit 2056 determines coordinates which is spaced apart by a predetermined distance in a direction set based on at least one of the following factors, as the display position of icon. Here, the factors are (1) the setting of right or left handedness, (2) a drawing direction as viewed from the coordinates of a pen-tip position, (3) the curvature of a drawn locus, (4) user's preset preferences, and so forth. The predetermined distance is a distance determined beforehand which is reachable by user's fingers from a position where the drawing has been interrupted. The thus determined display position of icon is supplied to the drawing unit 2058.

The icon position determining unit 2056 determines the position of icon based on the following criteria 1 to 4 for judgment, for instance.

1. If the dominant hand is set to the right hand, a direction other than a right side of the pen-tip position hidden by the user's hand itself will be selected.
2. If the drawing direction obtained from a change in the coordinates of pen-tip position is in an upper right position, for instance, a direction other than the upper right will be selected.
3. The interior or the exterior of a (closed) curve is selected based on the curvature obtained from an immediately previous locus.
4. If the user has selected a mode where an icon is displayed in an upper left position of the tip of the pen-shaped device, the upper left position will always be the icon position unless the upper left position is the drawing position.

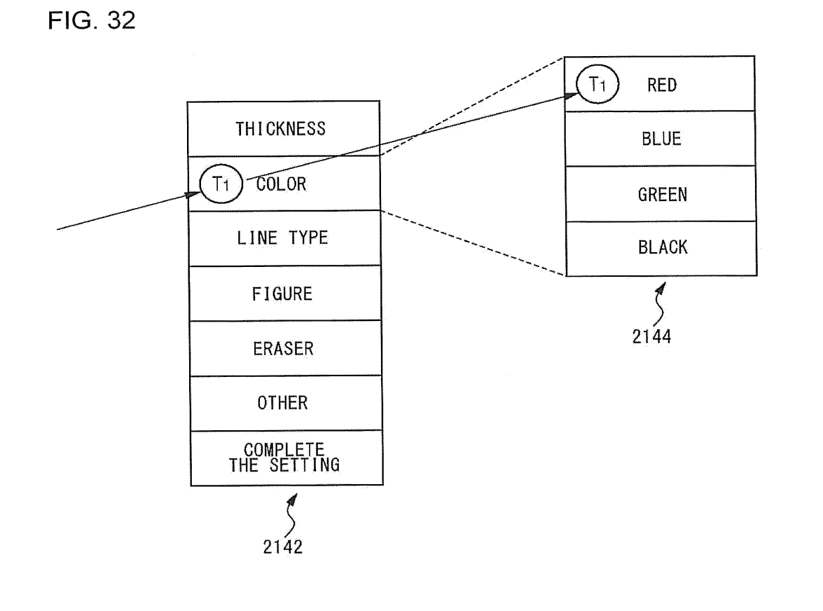

The icon function setting unit 2066 sets functions which are registered in the toggle switch icon described later. This will be described in conjunction with FIG. 32.

The drawing unit 2058 continuously joins together the coordinates of the pen-tip position received, per captured image, from the indication point detector 2052 so as to identify the locus of the indication points of the pen-shaped device 2120. Then lines having characteristic features predetermined for identified loci are drawn. Here, the characteristic features include color, thickness, line type, and so forth. If the characteristic features are changed by the toggle switch described later, loci with the changed characteristic features will be drawn. A predetermined icon is drawn on the coordinates determined by the icon position determining unit 2056. Further, if the menu icon is clicked, the menu screen will be drawn near the menu icon. The drawing unit 2058 sends images including those to the image signal output unit 2060.

The image memory 2062 stores image data to be projected onto the screen 2110. The image data is supplied from an external apparatus, such as a personal computer (PC), via a not-shown interface. The image signal output unit 2060 combines image signals, based on the image data stored in the image memory 2062, and an image produced by the drawing unit 2058, and then outputs the thus combined image to the optical modulator 2012. As a result, the image where the lines drawn by the user S is added to the image signals is projected and displayed on the screen 2110. Note here that the image signal output unit 2060 may not output the image signals supplied from the image memory 2062 but output only the images of loci.

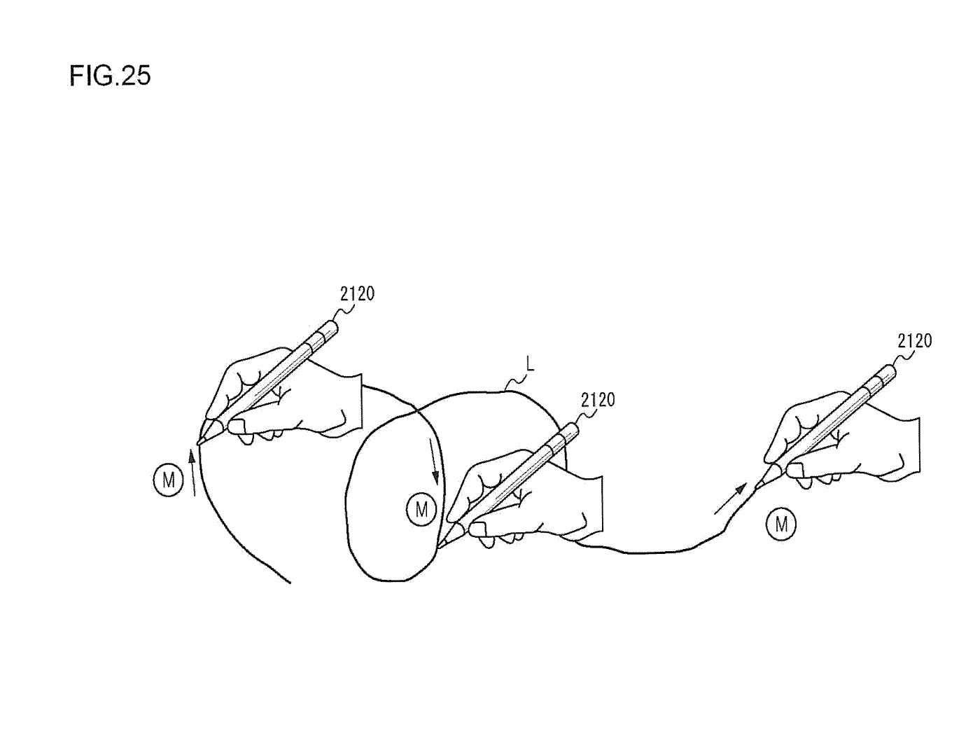

A description is subsequently given of an operation of the projection display system 2100 according to the fifth embodiment with reference to FIG. 25. FIG. 25 illustrates how loci are drawn on the screen by the use of the pen-shaped device 2120. The user moves the pen-shaped device 2120 while the pen-shaped device 2120 is being in contact with the screen plane. The camera 2030 captures images of the screen, and the indication point detector 2052 detects the bright point that emits light on the tip of the pen-shaped device 2120, from within the images captured by the camera 2030. Further, the indication point detector 2052 identifies the coordinates of the detected bright point in a projection image region. The drawing unit 2058 produces an image where loci obtained when the coordinates identified among the continuous captured images are joined together are drawn. The image signal output unit 2060 outputs an image where the thus drawn image is combined with a predetermined image signal, and the projection unit 2010 projects this image on the screen 2110. As a result, a locus L which is the trajectory that has tracked the tip of the pen-shaped device 2120 is projected and displayed on the screen 2110.

The icon position determining unit 2056 receives the coordinates identified by the indication point detector 2052, and determines a position where the menu icon is to be drawn. In the example of the FIG. 25, it is assumed that the user being right-handed is registered in advance. And the setting is made such that the menu icon is displayed on a left side of or under a locus according to the moving direction of the tip of the pen-shaped device 2120. Information on the thus determined drawing position of the menu icon is sent to the drawing unit 2058. The drawing unit 2058 produces an image where a menu icon image prepared beforehand is drawn at the determined position, and sends this image to the image signal output unit 2060. As a result, a menu icon M is displayed near the pen-tip position of the pen-shaped device 2120 on the screen. As the pen-shaped device 2120 is moved, the menu icon M is also moved on the screen following the movement of the pen-shaped device 2120.

In this manner, the menu icon is constantly displayed near the pen-shaped device following the movement of the pen-shaped device on the screen, so that the user can easily click on the menu icon using the pen-shaped device. Thus, the user does not need to extend his/her arm or walk to click on the menu screen located far from where the menu icon is.

It is preferable that the menu icon to be displayed does not impair the drawing by the user. For this purpose, the drawing unit 2058 may draw the menu icon in such a manner that the visibility of the menu icon when the drawing is being interrupted is higher than that at the time of drawing. Here, “when the drawing is being interrupted” corresponds to when the tip of the pen-shaped device is separated away from the screen plane, whereas “at the time of drawing” corresponds to when the tip thereof is in contact with the screen. While the user is drawing the locus, the drawing unit 2058 may display the menu icon with a subtle color, a transparent object, a low luminance level or light being constantly lit up, for instance. And while the drawing is being interrupted, the drawing unit 2058 may display the menu icon with a dark color, a translucent object, a high luminance level or blinking light, for instance.

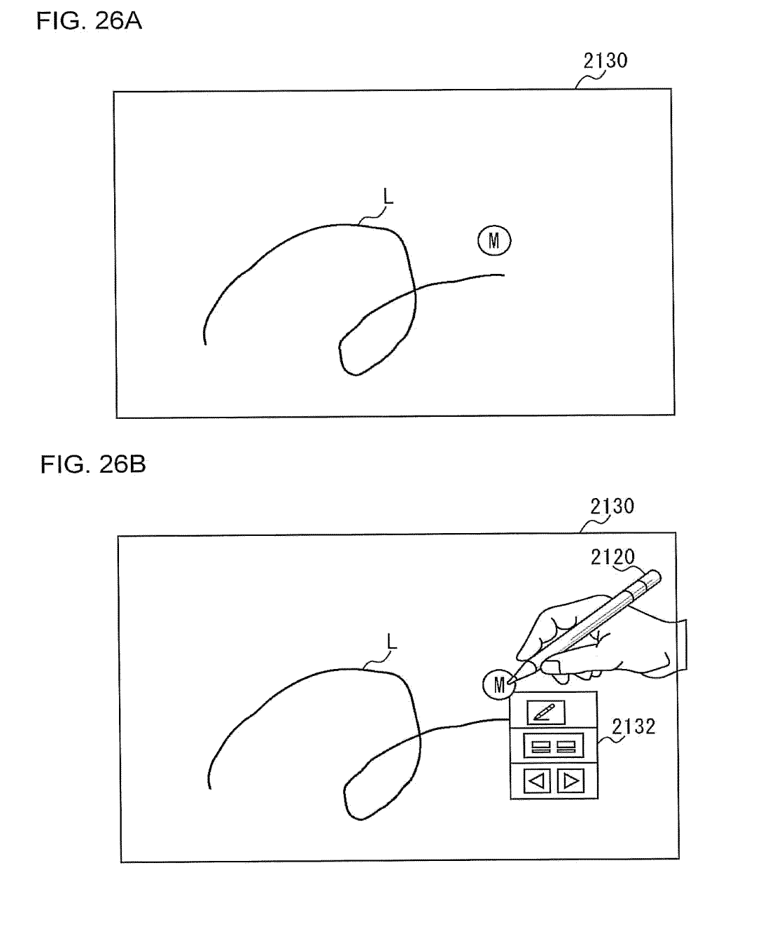

In conjunction with FIG. 25, a description has been given of an example where the menu icon is constantly displayed following the movement of the pen-shaped device on the screen. In contrast thereto, in the example of FIG. 26A, the menu icon M is displayed near the end of locus when the user completes the drawing of locus and the pen-shaped device is separated apart from the screen 2130. In this case, the menu icon M continues to be displayed on the screen without disappearing from the screen before a predetermined period of time has elapsed after the drawing was interrupted. During the predetermined period of time, a menu screen 2132 is expanded and displayed near the menu screen 2132 as shown in FIG. 26B if the user clicks on the menu icon M using the pen-shaped device 2120. This menu screen 2132 may contain any optical function items. For example, the menu screen 2132 may contain the setting of locus line (e.g., color, line type, and thickness), the movement of screen (e.g., previous screen and next screen), full-screen display, screen clear, screen saving, and so forth as the functional items. As a predetermined period of time elapses, the drawing may be determined to have been completed and therefore the menu icon may be deleted.

Instead of after the drawing was interrupted, the menu icon may be displayed near the tip of the pen-shaped device when the movement rate of locus becomes smaller than a predetermined value. Also, the menu icon may be displayed when the camera 2030 detects the pen-shaped device for the first time.

It is preferable that the user can set, on a predetermined menu screen, whether the menu icon is constantly displayed or it is displayed only when the drawing is being interrupted.

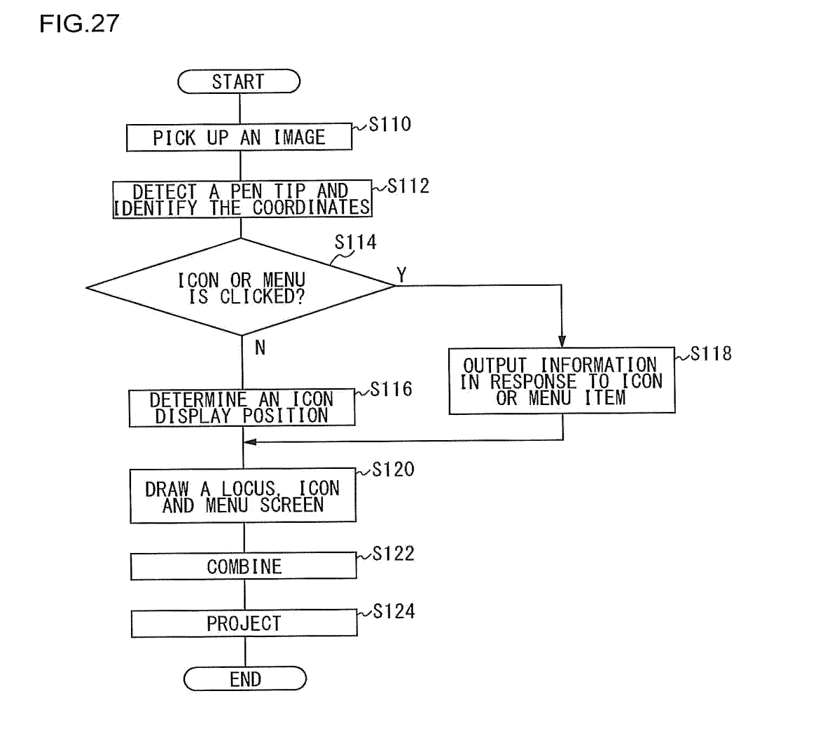

FIG. 27 is a flowchart of a process for drawing a locus on the screen by the use of a pen-shaped device in the projection display system 2100. First, the camera 2030 captures an image of a projection image region on the screen (S110). The indication point detector 2052 detects a bright point of indication point of the pen-shaped device within an image captured by the camera 2030 and identifies the coordinates of the detected bright point thereof. The operation determining unit 2054 compares the coordinates of the tip of the pen-shaped device with the coordinates of the currently displayed icon or the menu screen, and determined if the icon or menu item has be clicked (S114).

If the icon or menu item is not clicked (N of S114), the icon position determining unit 2056 will determine a position that does not interfere with the drawing by the user (S116). If the icon or menu item has been clicked (Y of S114), the operation determining unit 2054 will inform the drawing unit 2056 accordingly (S118).

The drawing unit 2058 draws the locus of the pen-shaped device based on the coordinates of the tip of the pen-shaped device determined by the indication point detector 2052 and produces an image where the menu icon has been drawn at a menu position determined by the icon position determining unit 2056 (S120). If a notification indicating that the icon has been clicked is conveyed from the operation determining unit 2054, the menu screen will be displayed near the icon. If a notification indicating that the menu item has been clicked is conveyed from the operation determining unit 2054, the characteristic feature or the like of line is switched according to the menu item. The image signal output unit 2060 combines the image produced by the drawing unit 2058 with the image signal fed from the image memory 2062 (S122), and projects the thus combined image onto the screen by the projection unit 2010 (S124).

### Sixth Embodiment

In the fifth embodiment, a description has been given of a case where the menu icon with which to display a predetermined menu screen is displayed following the tip of the pen-shaped device. In still another embodiment, the user may configure a toggle switch icon capable of freely changing the setting contents in such a manner that the toggle switch icon is displayed following the tip of the pen-shaped device.

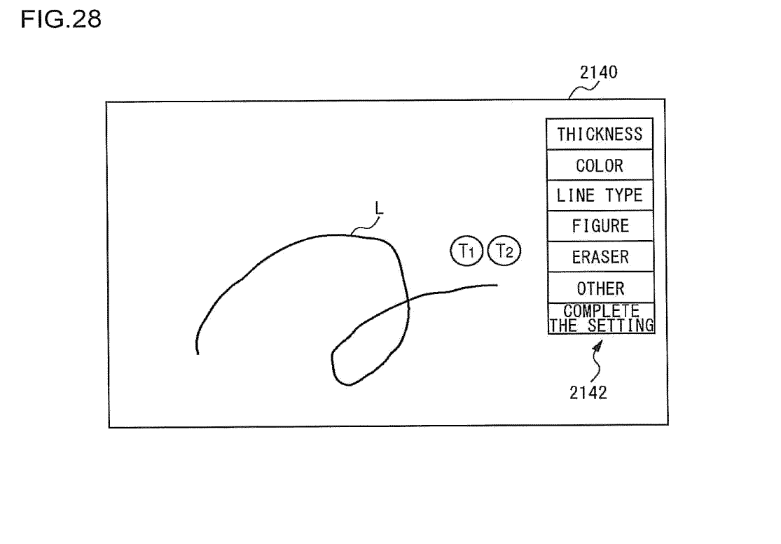

FIG. 28 is an example of projection image 2140 in a sixth embodiment of the present invention. The locus L is displayed similarly to FIG. 25 and FIGS. 26A and 26B. However, FIG. 28 differs from FIG. 25 and FIGS. 26A and 26B in that toggle switch icons T1 and T2 instead of the menu icon are displayed near the end of the locus. Also, a toggle switch setting change area 2142 is displayed in the right-hand edge of the projection image.

The user can easily change various functions by clicking on the toggle switch icon using the pen-shaped device. It is to be noted here that one toggle switch icon or three or more toggle switch icons may be provided.

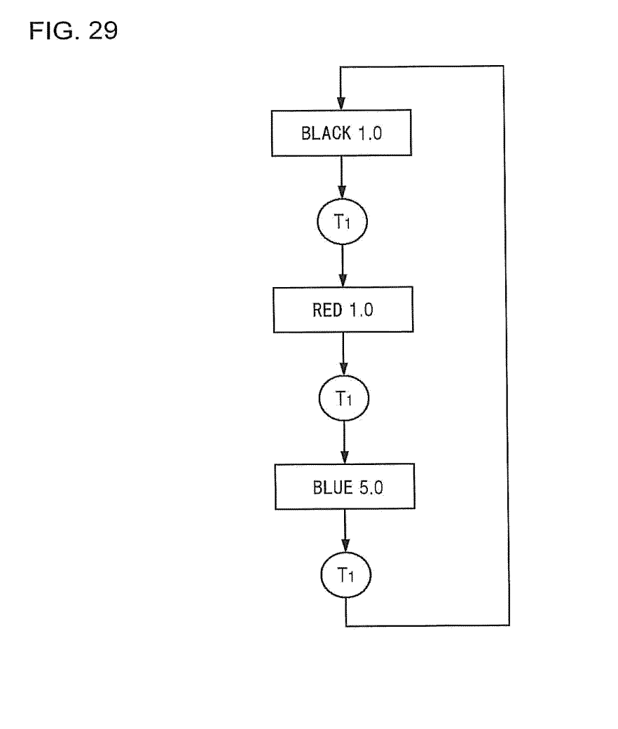

FIG. 29 to FIG. 31 are charts each showing an example of setting contents of the toggle switch icon.

FIG. 29 shows a setting where the color of pen, namely the color of locus, is changed by the toggle switch. When the pen-shaped device is set to “color: black, thickness: 1.0”, clicking on the toggle switch T1 switches the setting to “color: red, thickness: 1.0”. Further clicking on the toggle switch T1 switches the setting to “color: blue, thickness: 5.0”. Further clicking on the toggle switch T1 returns the setting content to the initial setting of “color: black, thickness: 1.0”.

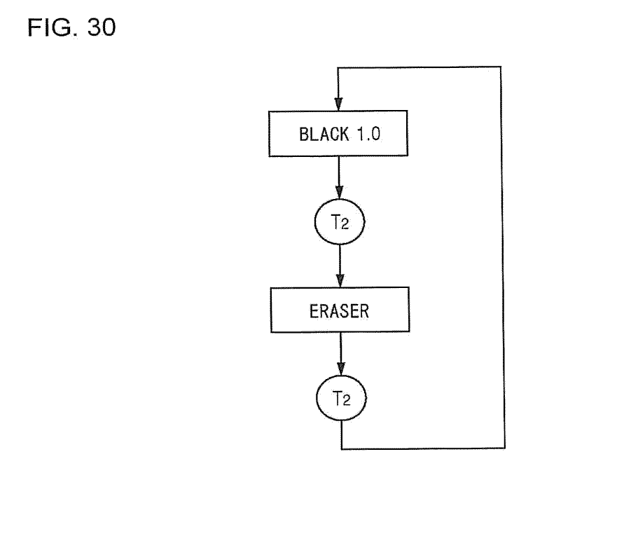

FIG. 30 shows a setting where a pen function and an eraser function are switched by the toggle switch. When the pen-shaped device is set to “color: black, thickness: 1.0”, clicking on the toggle switch T2 switches the pen function to the eraser function. Further clicking on the toggle switch T2 returns the setting to the initial setting.

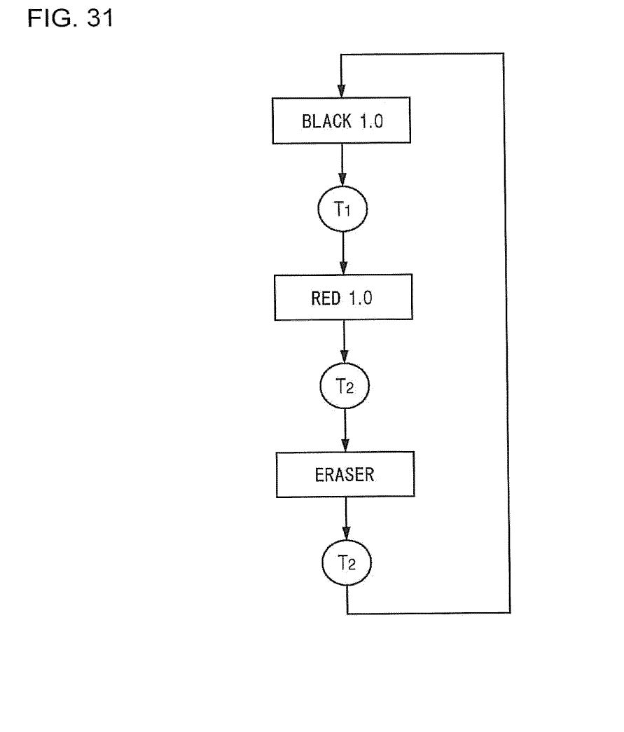

FIG. 31 is an example showing a change in function when the toggle switch T1 of FIG. 29 and the toggle switch T2 of FIG. 30 are used in combination. When the pen-shaped device is set to “color: black, thickness: 1.0”, clicking on the toggle switch T1 switches the setting to “color: red, thickness: 1.0”. Clicking on the toggle switch T2 switches the pen function to the eraser function. Further clicking on the toggle switch T2 returns the setting to the initial setting.

FIG. 32 explains a method employed when the user sets a desirable function to a toggle switch icon. The user clicks on and then drags a toggle switch icon (T1 in FIG. 32) to which a desired function is to be set, and moves the icon to the switch setting change area 214 located on the right-hand edge of the screen. As the toggle switch icon is moved to an item to which the user wishes to set among the respective items in the setting change area 2142, subitems 2144 of the item are expanded and displayed to the right of the item. The user moves the toggle switch icon T1 over a function which is set after one-time click on the toggle switch and then drops it. This operation sets a function where the pen function is set to “color: red” at the one-time click, to the toggle switch icon T1.

If the user wishes to set another function at the time of double click, he/she will again click on and drag the toggle switch icon T1 and move the icon T1 over an item to which he/she wishes to set the function. The similar operation will be repeated at the time of n-times click (n being an integer of 3 or greater)

Various functions other than those described above may be set to the toggle switch icon. For example, a function may be set where the page flips back and forth per click on the toggle switch.

As described above, by employing the fifth and sixth embodiments, a predetermined icon is displayed following the tip of the pen-shaped device operated by the user, in the system that captures the light projected onto the screen from the pen-shaped device and thereby detects the locus of the pen-shaped device. Thus, the user can easily utilize the menu function. The system is configured such that when images are projected onto a large screen, the menu function can be used at once without extending his/her arm or moving by walk to reach the menu screen located far from the user. Thus, the fifth and sixth embodiments are particularly advantageous in such a respect. Further, where a plurality of users are drawing simultaneous, the menu icon is displayed at the each user's drawing position, so that there is no need for the users to crisscross with each other.

Also, a predetermined icon is displayed in such a position as to not interfere with the drawing by the user, based on the user's initial setting, the drawing direction and the like. Thus, the user can draw lines or else in a stress-free manner. Also, since the user himself/herself can set a change in function through the toggle switch icon, the operability can be improved. Further, for example, it is possible to achieve a function associated with a right click on the mouse in the projection display system, without additionally providing a switch or the like to the pen-shaped device.

In the fifth and sixth embodiments, a description has been given of a case where the menu icon and toggle switch icon are displayed following the drawing, but this should not be considered as limiting. For example, the menu screen itself may follow the drawing.

In the above-described fifth and sixth embodiments, a description has been given using a system including a projection-type display apparatus that displays the projected images on the large screen in particular, as an example. However, this should not be considered as limiting and the present embodiments may be applied to a system that detects the locus of the pointing device on the screen, such as electronic blackboard, and displays the detected locus on the display. In this case, the pointing device may be used as a substitute for the mouse and the like.

In the above-described fifth and sixth embodiments, a description has been given of a case where the indication point detector 2052 detects bright points of light irradiated from the tip of the pen-shaped device 2120 as the indication points. However, the present embodiments are not limited to a structure and a method where the tip of the pen-shaped device 2120 is detected as the indication point. For example, the bright point on the screen indicated by a laser pointer, the tip of pointing stick having no light-emitting device or a human's fingertip may be detected as the indication point.

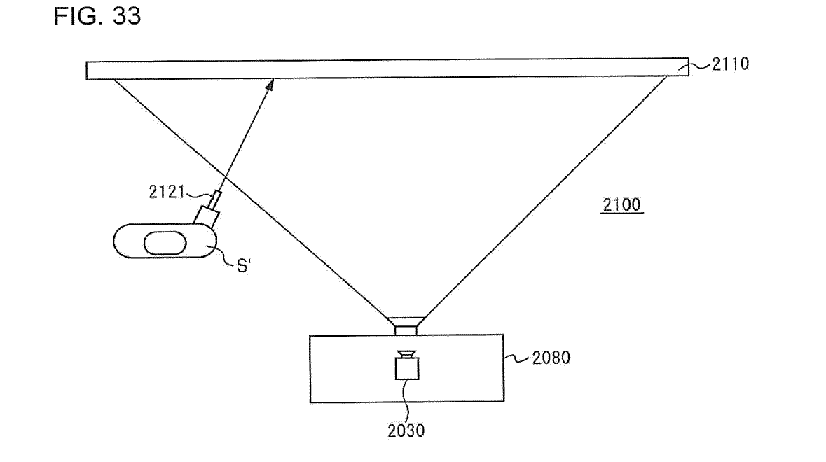

If a bright point on the screen indicated by the laser pointer is detected as an indication point, the laser pointer and the screen will not be in contact with each other. More specifically, as shown in FIG. 33, a user S′ who is located away from the screen 2110 operates a laser pointer 2121. At this time, the indication point detector 2052 detects the bright point of laser light outputted from the laser pointer 212 on the screen 2110 as the indication point.

The present invention has been described based on the first to the sixth embodiments. These embodiments are intended to be illustrative only, and it is understood by those skilled in the art that various modifications to constituting elements and processes as well as arbitrary combinations thereof could be developed and that such modifications and combinations are also within the scope of the present invention.

In the above-described embodiments, an example where the optical input system is applied to the projector has been described but the present embodiments are also applicable to cases where the user draws lines or the like on an image displayed on a display unit such as PC or TV (e.g., LCD display or organic EL display). In such a case, the image pickup unit needs to be installed in a position where a display screen can be captured.

In each of the above-described embodiments, a system including a projection-type display apparatus that displays the projection images on the screen has been described as an example. However, the present embodiments may be applicable to a system that detects the locus of the pointing device on the screen (e.g., electronic blackboard) and displays the detected locus on the display unit. In this case, it is not necessary that a drawing area by the pointing device and an area where the image corresponding to the locus is displayed are the same. For example, the locus of the pointing device on a certain screen may be displayed on another screen or display unit.

What is claimed is:

1. An information display system including a pointing device and a control apparatus for detecting a locus of tip of the pointing device, the pointing device including:
a light emitting part configured to irradiate radiation light that radiates with the tip of the pointing device on a predetermined plane as a center,
the control apparatus including:
an image pickup unit configured to pick up a region including the radiation light on the predetermined plane;
a detector configured to detect the radiation light from an image picked up by the image pickup unit; and
an estimation unit configured to estimate the position of the tip of the pointing device from the radiation light detected by the detector.

2. An information display system according to claim 1, wherein the pointing device has a slit that forms radiation light such that an intersection point of at least two line segments extending radially with the tip thereof as a center agrees with the tip of the pointing device.

3. An information display system according to claim 1, wherein the estimation unit detects a rotation of the pointing device, based on a comparison of the radiation light made among a plurality of images picked up by the image pickup unit.

4. An information display system according to claim 1, wherein the estimation unit estimates an angle of the pointing device relative to the predetermined plane, based on matching between an outer shape of the radiation light and form patterns stored beforehand.

5. An information display system according to claim 1, wherein the estimation unit estimates the distance between the predetermined plane and the tip of the pointing device, based on a comparison of the radiation light among a plurality of images picked up by the image pickup unit.

6. An information display system including a pointing device and a control apparatus for detecting a locus of tip of the pointing device, the pointing device including:
a first light-emitting part configured to form a first irradiation region along a direction of the tip thereof;
a second light-emitting part configured to form a second irradiation region in such a manner as to surround the first irradiation region; and
a switch configured to turn on and off either one of the first light-emitting part and the second light-emitting part,
the control apparatus including:
an image pickup unit configured to pick up images of the first irradiation region and the second irradiation region on a predetermined plane;
a detector configured to detect the first irradiation region and the second irradiation region from an image picked up by the image pickup unit;
an estimation unit configured to estimate the position of the tip of the pointing device from a position or shape of the first irradiation region or the second irradiation region; and
a notification unit configured to convey an operation of the switch to an external device when the first irradiation region or the second irradiation has been detected.

7. An information display system according to claim 1, further including:
a drawing unit configured to produce an image, where the locus of tip thereof is drawn, by referencing the position of the tip estimated for a plurality of images picked up by the image pickup unit; and
an output unit configured to output the drawn image to an image display apparatus.

8. An information display system according to claim 7, wherein the control apparatus constitutes a part of a projection-type display apparatus, and
the projection-type display apparatus is configured to project and display the image outputted from the output unit on the predetermined plane.

9. An optical input system, comprising:
an image pickup unit configured to pick up an image of a luminous body itself in an input device carrying the luminous body and reflected light of light irradiated from the luminous body to a display surface; and
a determining unit configured to compare a barycentric position of light of the luminous body itself with that of the reflected light in an image captured by said image pickup unit, and configured to determine that the input device and the display surface are in contact with each other when the barycentric positions thereof are associated with each other and determine that the input device and the display surface are not in contact with each other when the barycentric positions thereof are not associated with each other.

10. An optical system according to claim 9, further comprising an input control unit configured to set an operation mode to a non-contact input mode when a decision result by said determining unit indicates that the barycentric position of light of the luminous body itself and that of the reflected light are farther than a preset distance, and configured to set the operation mode to a contact mode, otherwise.

11. An optical system according to claim 9, further comprising an input control unit configured to output coordinates corresponding to the barycentric position of the reflected light to a controller, when a decision result by said determining unit indicates that the barycentric position of light of the luminous body itself and that of the reflected light are farther than a preset distance, and configured to output coordinates corresponding to either one of the barycentric position of the luminous body itself and that of the reflected light to the controller, otherwise.

12. An optical system according to claim 9, wherein the input device is formed like a pen, and power supply of the luminous body is turned on or off by removing or attaching a cap to a rear end of the pen.

13. A projection-type image display apparatus equipped with an optical input system according to claim 9, the apparatus comprising:
an interface configured to output coordinates outputted from the optical input system, to an image processing apparatus and configured to receive an input of image data after drawing data has been superposed on the coordinates by the image processing apparatus; and
a projection unit configured to project the image data on the display surface.

14. A program embedded in a non-transitory computer-readable medium and executable by a control apparatus in an information display system including the control apparatus for detecting a locus of indication point relative to a predetermined plane, the program comprising:
a detecting module operative to detect coordinates of the indication point from an image where a region containing the indication point on the predetermined plane is captured;
a drawing module operative to draw the locus of the indication point and produce an image where a predetermined icon is drawn near the indication point; and
an outputting module operative to output the produced image to an image display apparatus.

15. An information displaying program according claim 14, further comprising a module operative to determine a direction, where the locus of the indication point is drawn, and select a display position of the predetermined icon from a direction different from said direction where the locus of the indication point is drawn.

16. An information displaying program according to claim 14, wherein the predetermined icon is a menu icon that displays a predetermined menu screen when clicked.

17. An information displaying program according to claim 14, wherein the predetermined icon is a toggle switch icon where setting of line of the locus is changed for every click.

18. An information displaying program according to claim 14, wherein the information display system includes a pointing device structured to indicate the indication point, and
wherein when the indication point of the pointing device is separated away from the predetermined plane, said drawing module draws the icon.

19. An information displaying program according to claim 14, wherein the information display system includes a pointing device structured to indicate the indication point, and
wherein said drawing module draws the icon in such a manner that visibility of the icon when the indication point of the pointing device is separated away from the predetermined plane is higher than that when the indication point of the pointing device is in contact with the predetermined plane.

20. An information display system including a control apparatus for detecting a locus of indication point relative to a predetermined plane, the control apparatus including;
a detector configured to detect coordinates of the indication point from an image where a region containing the indication point on the predetermined plane is captured;
a drawing unit configured to draw the locus of the indication point and produce an image where a predetermined icon is drawn near the indication point; and
an output unit configured to output the produced image to an image display apparatus.
